(19) United States
(12) Patent Application Publication
(10) Pub. No.: US 2007/0155418 A1
(43) Pub. Date: Jul. 5, 2007

(54) EXPANDABLE FUNCTIONS FOR CELLULAR PHONES

(76) Inventors: Jeng-Jye Shau, Palo Alto, CA (US); Albert Shau, Palo Alto, CA (US)

Correspondence Address: Jeng-Jye Shau, 991 Amarillo Ave., Palo Alto, CA, 94303, US

(21) Appl. No.: 11/306,450

(22) Filed: Dec. 29, 2005

(51) Int. Cl. H04M 1/00

(52) U.S. Cl. 455/550.1

(57) ABSTRACT

The present invention provides structures and methods for expanding the functions of cellular phones. Practical applications in using cellular phones to support the functions of remote controllers, credit cards, automatic teller machine (ATM) cards, membership cards, insurance cards, business cards, and entertainment applications are discussed. Security features for cellular phone resource management systems and cellular phone direct communication methods are provided to facilitate expandable cellular phone functions.

### BACKGROUND OF THE INVENTION

The present invention relates to methods to expand the functions of cellular phones, and more particularly to methods to expand the functions of cellular phones to support the functions of remote controllers, personal identification, and entertainment applications.

In the past decade, usage of cellular phones progressed at an explosive rate. Besides television sets, cellular phones are probably the most popular electrical appliances.

The structure of a typical prior art cellular phone is illustrated in FIGS. 1(a-c). This cellular phone (100) has a base panel (102), and a display panel (114). The display panel (114) can be rotated against an axis (101) relative to the base panel (102), so that the cellular phone can be folded to save space while not in use. FIG. 1(a) depicts the front view of an unfolded cellular phone (100), FIG. 1(b) shows the side view when the cellular phone (100) is folded, and FIG. 2(c) shows its front view when the cellular phone is folded. Typically, a keyboard (103) is placed on the base panel (102). This keyboard (103) typically has number/alphabet buttons (104), direction buttons (107), control buttons (105), a power on/off button (108), and selection buttons (106). Sometimes the keyboard (103) also has special buttons such as a button that can activate internet access (109). Other special buttons (110-113) such as volume control buttons (112, 113) also can be placed sideways. Typically, the microphone port (122), battery charger input port (117), and head set interface port (118) are placed near the bottom of the base panel (102). A cellular phone needs a radio frequency (RF) antenna for emitting and receiving RF electromagnetic (EM) waves. In this example, the RF antenna (121) is hidden in the rotational axis (101). The display panel (114) typically has a liquid crystal display (LCD) panel (115), and an audio speaker (116). Many cellular phones also can have a built-in digital camera (119), and a secondary LCD display (120).

FIG. 2 is a functional block diagram showing components of a typical cellular phone. A cellular phone has RF interface circuits that transmit/receive RF signals to/from an RF antenna. The RF interface circuits also can support other types of RF devices such as “Blue Tooth” short distance wireless connections. This RF interface is typically a complex integrated circuit (IC) that controls RF operations and communicates with the central processing unit (CPU) of the system. The CPU is typically a microprocessor. The CPU for cellular phones also needs to have digital signal processing (DSP) capability. Sometimes a separate DSP processor is used. A system memory device stores software programs and data needed to support cellular phone operations. Typically, a combination of static random access memory (SRAM) and FLASH memory is used as the cellular phone system memory device. The CPU also communicates with audio interface circuits that control audio devices such as speakers and microphones. The user also can use an external headset connected through the headset interface as an audio device. Sometimes the headset interface is generalized into an interface port that can be connected to memory cards, Personal Digital Assistant (PDA) devices, or other types of devices. The cellular phone also can have separate interface ports for those external devices. The user interface to the CPU is typically provided by a keyboard that functions in similar ways as computer keyboards. The graphical display of the system is typically an LCD panel driven by an LCD driver IC that is also controlled by the CPU. For power saving reasons, the LCD panel often relies on ambient light; a light source is therefore provided to handle the situation when the environment is dark. Current art cellular phones often have a built-in digital camera that comprises of a camera lens and an area sensor IC. The digital camera uses the LCD panel as a display device. The system power source is typically a battery charged through a battery charger port.

FIG. 2 shows that a cellular phone is actually a highly sophisticated system that is as complex as a fully equipped computer system; it is like a miniature computer system in that it has all the components, but the capacity of each component is smaller. Most of the structures/methods/algorithms applicable to computer systems are applicable to cellular phones. In the mean time, cellular phones are battery powered portable devices so they are very sensitive to power usage. The storage capacity of cellular phone system memory is also much smaller than that of computer systems. Although the resource management system for a cellular phone can be similar to a computer operating system, it is desirable to develop additional resource management methods optimized for cellular phones.

The typical components of cellular phones are very powerful. Cellular phones already can serve as a wireless telephone, a camera, a user interface to the internet, an alarm clock, a calendar, and many other applications. However, we believe cellular phones have reached only a small percentage of their full capability. This is a powerful device that is carried by most people in the world, and capable of reaching most people in the world. It is fully capable of providing many applications that will greatly improve the quality of life for human beings. It is highly desirable to expand the capabilities of this powerful and popular device to serve more functions. The present invention will provide methods to expand the applications of this powerful device while using the built-in components of cellular phones as much as possible.

Many methods have been developed to use mobile devices for additional applications. In U.S. patent application Ser. No. 10/095,603, Yach etc. disclosed a method for initiating a telephone call using a dual mode mobile device having data and voice components. The data component was used for storing, retrieving, receiving and displaying data, and the voice component for establishing telephone calls. This method allows a cellular phone to send/receive data, instead of just voice, using existing RF wireless cellular phone signals. In U.S. patent application Ser. No. 09/835,362, Lai etc. disclosed methods to use cellular phones to play real time interactive video games. In U.S. patent application Ser. No. 10/786,961, Clark etc. disclosed methods to update mobile device databases through communication systems. These methods must go through prior art cellular stations, and did not provide necessary security features.

In U.S. patent application Ser. No. 10/786,961, Zinn etc. disclosed a wireless device comprising of a short-range transceiver for communicating with an auxiliary device. Zinn's method limited communications to an auxiliary device only. In U.S. patent application Ser. No. 10/709,126, Chen disclosed an external bilateral telephone interface remote control system with complex structures. Chen's remote control system does not use built-in capabilities of cellular phones. In U.S. patent application Ser. No. 10/901,794, DiFazio et al. disclosed a charger configured to backup data in a portable device while charging a battery of the portable device. The method limits the communication to a charger.

In U.S. patent application Ser. No. 11/144,363, Apitzer etc. disclosed a portable transaction device comprising of memory to hold information regarding a financial card, a slot to interface with a reprogrammable card, and software to generate single use transaction numbers, which is like a portable prior art credit card machine.

In U.S. patent application Ser. No. 11/143,494, Yamazaki disclosed an acceptance/reception separating system in a financial institution that is connected to external communications such as internet or telephone systems. In U.S. patent application Ser. No. 10/323,593, Khan disclosed a similar system. In U.S. patent application Ser. No. 11/034,162, Nel disclosed another similar system. These methods try to utilize the capability of modern communication systems to serve payment applications, but those methods do not utilize the processing capability of cellular phones and do not provide proper security features.

Current art computer operating systems provide security by assigning priority levels to files stored in memory devices. For example, the personal computer “Windows” operating system assigns priority levels such as “system”, “read only”, and “archived” to files. For another example, the Unix operating system (and derivatives of Unix such as Linux) defines three levels of priorities (owner, group, and user) for three types of operations (read, write, and execution) to each file. An individual user owns lower priority to execute/read/write a limited subset of files. Such priority systems have been proven to be broken by hackers. Current art computer systems rely on passwords to verify the identity and priority of each user. It is well known that hackers are able to crack such systems by guessing the passwords through intelligent trial and error. Current art software systems are also known to be attacked by software “viruses” that invite careless users to execute harmful software. There are also “spy” programs that get into systems and steal critical information without notifying the owners. There are software “back doors” that allow an intruder to execute commands without notifying the owners. Such ill purposed software has caused huge damages to computer users. Allowing cellular phones to be attacked by similar problems can cause catastrophic results. We need better security features if we want to allow the flexibility to expand the capabilities of cellular phones.

In U.S. patent application Ser. No. 11/049,772, Ma disclosed methods of selectively controlling read and write accesses to data stored in a data storage device by enabling or disabling one or more communication interfaces of said data storage device. Ma's methods are designed to protect the users while providing no protection to service providers. In U.S. patent application Ser. No. 10/786,961, Tenaka etc. disclosed a method to transmit important data in the storage device of a portable device to other devices using a wireless communication means to judge whether the first portable device is abnormal (e.g., when being stolen) or not based on an output of a status detector means. This method requires external help and a need to determine what is “abnormal”. In U.S. patent application Ser. No. 10/859,487, Pearson etc. disclosed a system for performing authentication by engaging the user in a challenge-response sequence that is based on recognition of the user's utterance and also upon verification of the user's speech patterns or voiceprint. Pearson's method is a good way to determine the identity of the cellular phone user, but it does not provide other critical security features.

These developments cannot provide the methods suitable for expanding the functions of cellular phones. It is therefore highly desirable to provide proper methods to remove barriers in expanding the capabilities of cellular phones.

### SUMMARY OF THE INVENTION

The primary objective of the present invention is to provide structures and methods for expanding the functions of cellular phones. The other objective of this invention is to use cellular phones as remote controllers. Another objective of this invention is to use cellular phones as personal identity verification devices to support the functions of credit cards, automatic teller machine (ATM) cards, membership cards, insurance cards, and business cards. Another objective of this invention is to use cellular phones as music or movie players. Another objective of this invention is to provide direct cellular phone to cellular phone data transfer methods.

A “cellular phone” discussed in the present invention is a battery powered electrical device supporting the functions of a telephone using wireless communication through cellular stations. A cellular phone typically supports many other functions besides the functions of a telephone. “Expanding the functions of a cellular phone” means enabling additional functions on a cellular phone by providing additional resources (e.g. parameters, data, software programs, attached devices) to the cellular phone. A resource is something used to support system operations; a resource referred to in the present invention is typically a software/firmware resource (e.g. program, data, parameters, file, directory, folder, algorithm, identity verification mechanism, storage space, . . . etc) but it also can be a hardware device (e.g. speaker, LCD display, key board, IR emitter, FLASH memory, RF interface circuit, . . . etc). Many examples in methods to expand the functions of cellular phones are discussed in the present invention including different methods for using cellular phones to support the functions of remote controllers, credit cards, ATM cards, membership cards, insurance cards, and entertainment players.

One key requirement for expanding the functions of a cellular phone is to provide reliable security mechanisms for resource management. Prior art Unix operating system uses password identity checks to define three levels of priorities (owner, group, and user) for three types of operations (read, write, and execution) on each resource. Other than passwords, cellular phones can support additional identity verifications such as rhythm, voice recognition, finger print, signature, image, . . . etc. Prior art computer security features are designed to protect the computer systems; they are not designed from the viewpoint of resource providers. In preferred embodiments of the present invention, an additional identity called “guest user” is provided to enforce protection to both the cellular phone systems and the external resource providers. We also introduce more priority levels and a resource control mechanism called “resource access priority level” (RAPL). Anti-virus protection mechanisms such as the “sterilized-by-provider” (SBP) and “trusted-provider-list” (TPL) methods are developed for cellular phone systems.

One effective method to improve security is simplification. A prior art cellular phone communicates with another cellular phone through cellular stations or internet. Such communication methods are powerful but also dangerous because too many users can get into the system. The Cellular phone direct communication (CDC) methods provide one-to-one direct communications between two cellular phones without using other communication systems. CDC is very effective in supporting expanded functions of cellular phones.

While the novel features of the invention are set forth with particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIGS. 1(a-c) show the structure of a typical prior art cellular phone;

FIG. 2 is a symbolic functional block diagram for the cellular phone in FIGS. 1(a-c);

FIG. 3(a) shows the structure of a typical prior art television (TV) remote controller;

FIG. 3(b) shows a cellular phone equipped with an infrared device;

FIG. 3(c) is a symbolic functional block diagram for the cellular phone in FIG. 3(b);

FIG. 3(d) is a flow chart for the procedures to install additional functions into a cellular phone;

FIG. 3(e) is a flow chart for the sterilize-by-provider (SBP) mechanism;

FIG. 3(f) is a flow chart for a mechanism to download software from a trusted provider list (TPL);

FIGS. 3(g,h) are flow charts for the procedures to install software into cellular phone systems;

FIG. 4(a) shows the structure of a prior art remote control key;

FIG. 4(b) shows the structure of a cellular phone with an attached IR device;

FIG. 4(c) shows a cellular phone as a remote controller;

FIG. 4(d) shows a cellular phone as a remote controller with the help of a signal converter;

FIGS. 5(a-e) illustrate methods to transfer data directly from a cellular phone to another cellular phone or another device;

FIGS. 6(a-c) are flow charts describing methods to use cellular phones to support the functions of credit cards;

FIGS. 7(a-e) are flow charts describing methods to use cellular phones to support the functions of various identity cards;

FIG. 8(a) Shows a cellular phone with attached entertainment data device;

FIG. 8(b) is a flow chart describing operation of the device in FIG. 8(a);

FIG. 8(c) is a simplified system block diagram for the device in FIG. 8(a); and

FIG. 8(d) is a flow chart describing the procedures to download entertainment data.

### DETAILED DESCRIPTION OF THE INVENTION

Practical applications in expanding the functions of cellular phones to support the functions of remote controllers are first discussed to facilitate understanding of the present invention.

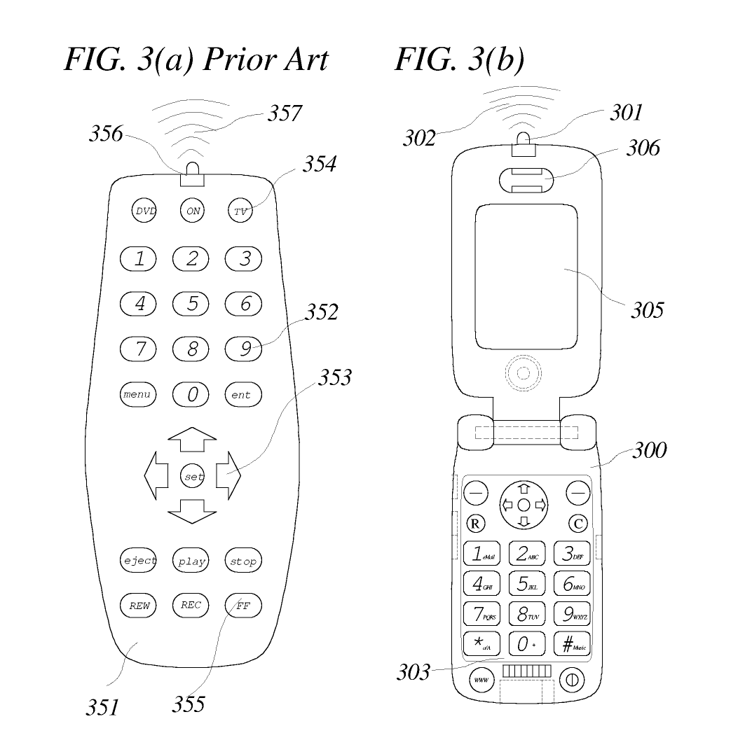

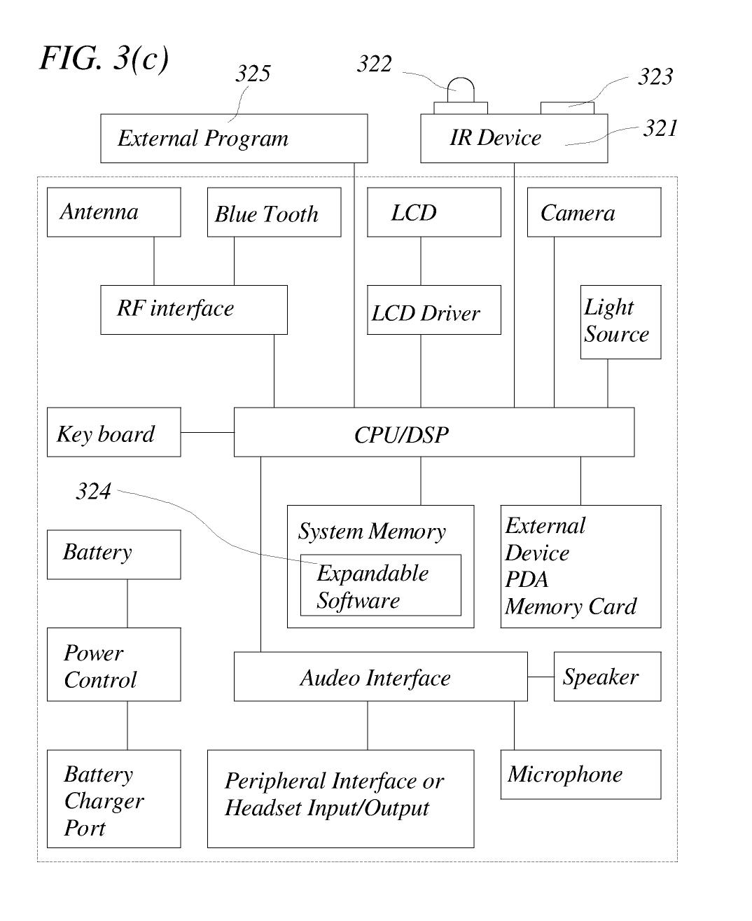

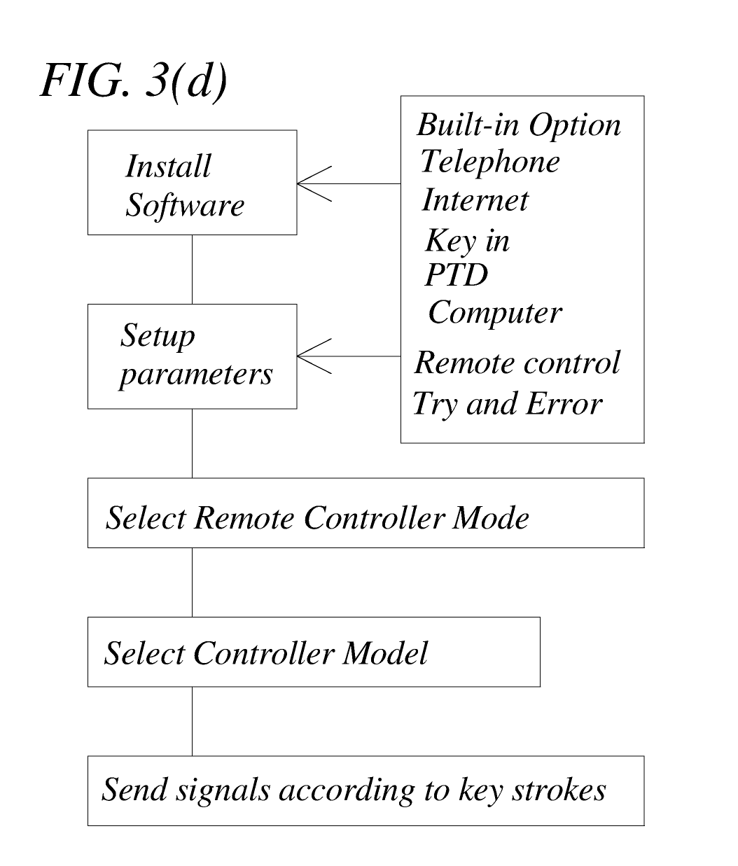

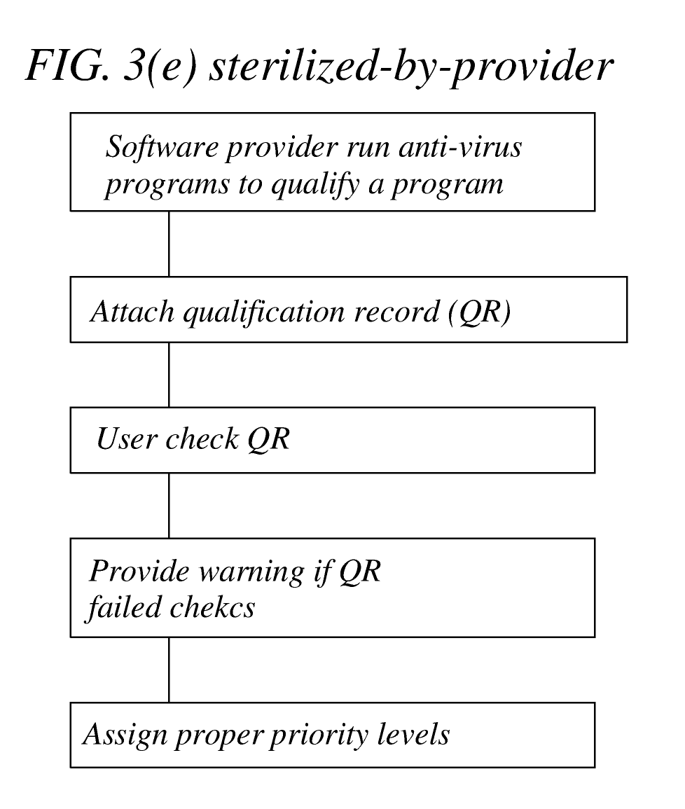

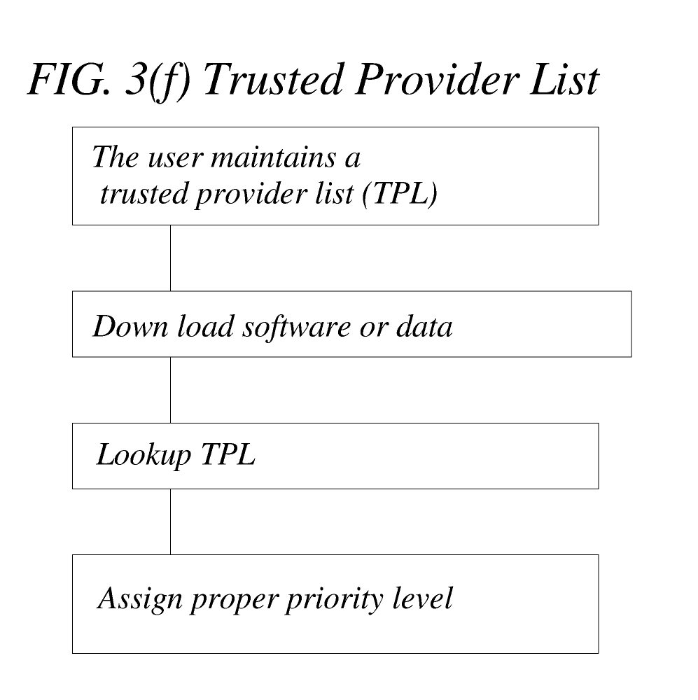

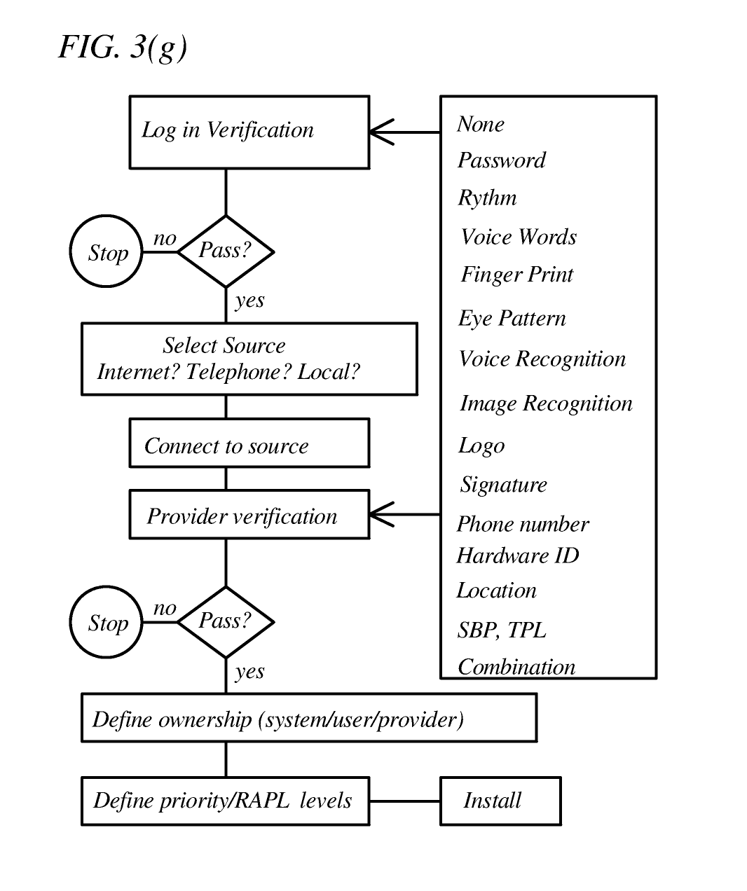

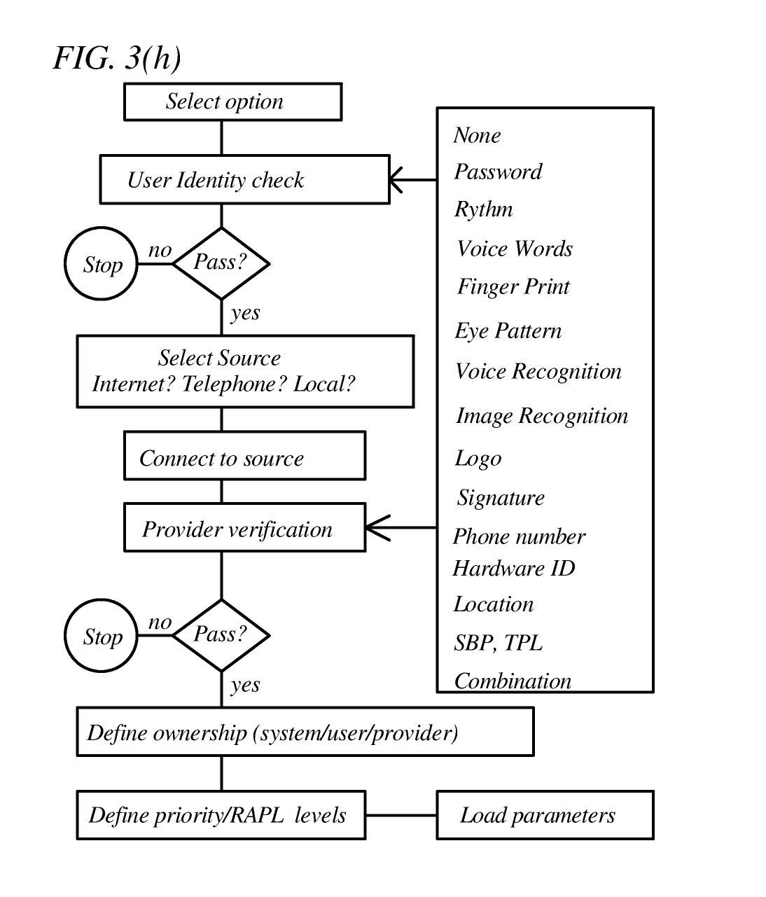

FIG. 3(a) illustrates the structure of a prior art remote controller (351). A remote controller is an electrical device that emits wireless control signals to control operations of appliances such as television (TV) sets, digital video disk (DVD) players, switches, or locks. For this example, the remote controller comprises of a keyboard with number buttons (352), direction buttons (353), select buttons (354), and control buttons (355). An infrared (IR) signal emitter (356) is placed at the tip of the remote controller. When the user presses a button, the internal control circuits send out IR signals (357) in a pre-defined format. An appliance (not shown) equipped with an IR detector decodes the emitted IR signals and executes pre-defined functions (e.g. change channel, increase volume, turn on/off) according to the received IR signals (357).

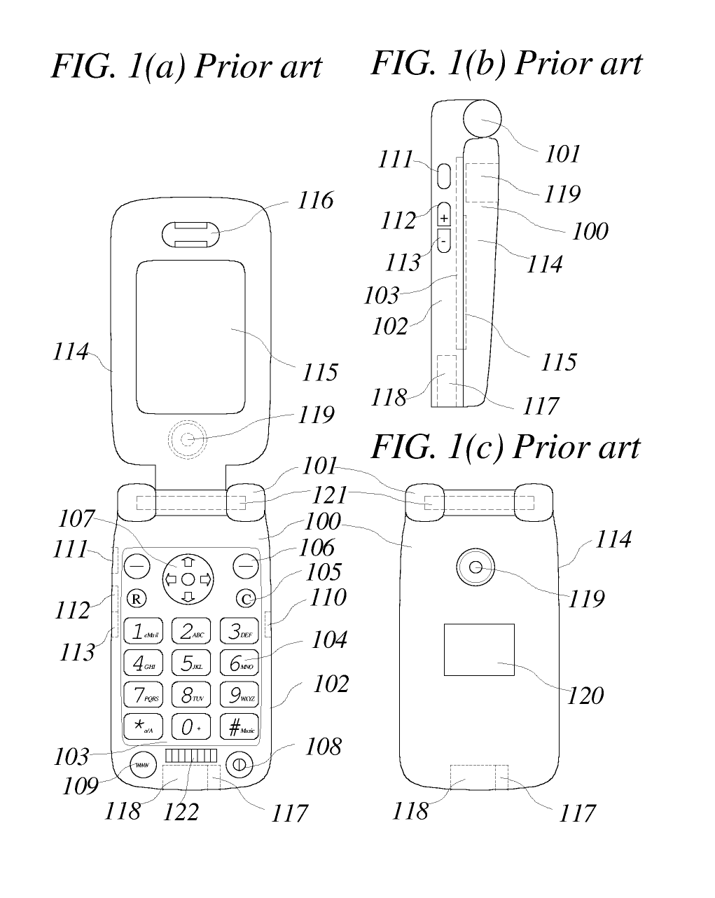

Comparing the remote controller (351) in FIG. 3(a) to the typical cellular phone (100) shown in FIG. 1(a), the cellular phone keyboard (103) has most of the necessary buttons needed to support remote control functions. Even when there are a few remote control buttons that are not defined in the keyboard, the cellular phone has the processing capabilities to re-define its buttons to support those special functions. The only missing component for the cellular phone in FIG. 1(a) is the infrared (IR) emitter (356).

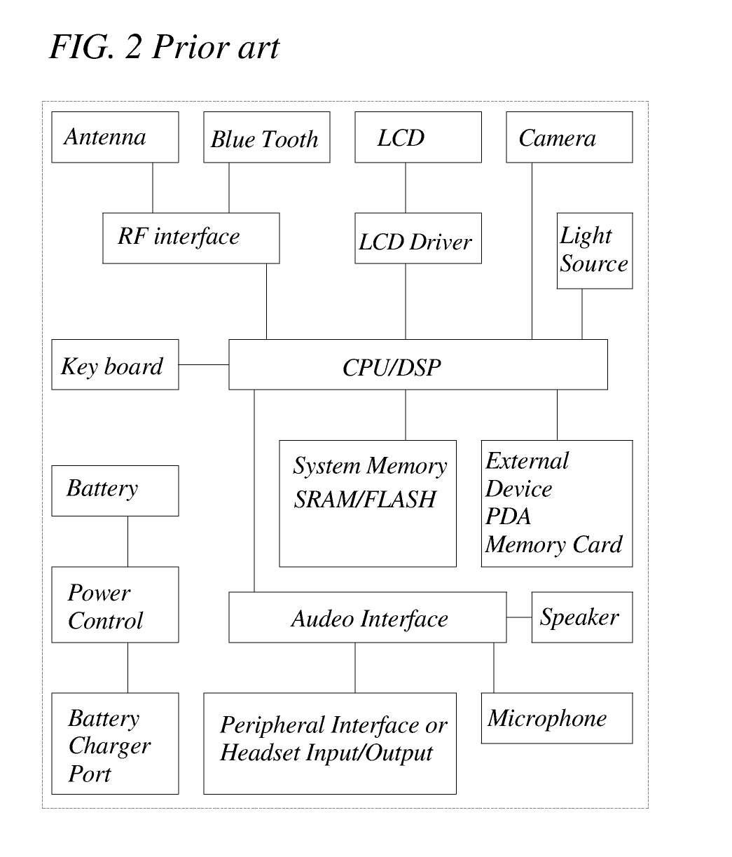

FIG. 3(b) shows a cellular phone (300) that has the same structures as the prior art cellular phone (100) in FIG. 1(a) except it is equipped with an IR device (301) that can emit IR signals (302). FIG. 3(c) is the functional block diagram for the cellular phone in FIG. 3(b). Comparing FIG. 2 to FIG. 3(c) shows that the cellular phone in FIG. 3(b) still has all the typical components of prior art cellular phone, and it has an additional IR device (321). This IR device (321) can be a simple IR emitter (322). For many applications, we would also like to have an IR detector (323). For more sophisticated applications, the IR device (321) also can have its own control circuits and drivers. In order to use cellular phone control circuits to output IR signals in the same formats as remote controllers, the most convenient method is to install software programs to control the IR device. It is desirable to have extra space in the system memory reserved for optional expandable software (324). Another option is to have interfaces to external programs (325) for supporting additional applications.

FIG. 3(d) is a flow chart showing example procedures used to install additional functions into the cellular phone. The first step is to install a software program into the system. For the example of a remote controller, this software treats the IR device (321) as an input/output (I/O) device, and instructs the CPU to drive the IR device (321) sending out IR signals according to pressed buttons. The software also may record parameters of different remote controllers, and/or help the user to input or select parameters. This software can be a built-in option provided by cellular phone manufacturers. The software also can be installed into or attached to the system. This software installation can utilize the cellular phone capability of connecting to telephone systems, the internet, personal digital assistant (PDA) devices, computers, or any other data transfer devices. For simple cases, it is also possible to key in the optional software. As shown in FIG. 3(d), the next step is to set up parameters for each remote control device we want to support. There are many remote controllers on the market. These remote controllers are similar in structure, but can follow different standards in sending control signals. It is desirable for the remote control software to support many types of remote controllers. To support a particular type/brand of remote controller, we should obtain control parameters to tell the cellular phone the format of remote control signals. Basically, the cellular phone CPU needs to know the format of remote control signals it needs to output when a button is pressed. Such parameters can be part of built-in parameters provided by the cellular phone manufacturer. We also can download the parameters through the internet (for example, visit the website of a TV vender to download the parameters), through the telephone system (for example, call a service number to obtain the parameters), or simply key in those parameters. Another way is to use an IR detector (323) to record signals emitted by an existing remote controller. In this way, the cellular phone will be able to reproduce the same signals when a button is pressed. The cellular phone also can output remote control signals of different formats to see if the appliance responds correctly or not, and determine the parameters by trial-and-error. To save storage area, we should have the option to store just a few sets of parameters that are the most useful for the cellular phone user.

After the cellular phone is setup to perform the functions of remote controllers, a user can use mode select functions to set the cellular phone into remote controller mode. The next step is to select the type of the remote controller to obtain the right parameters. After the cellular phone obtains necessary parameters, the cellular phone is able to send remote control signals in the correct formats; it is therefore able to perform the same functions as a remote controller.

It is desirable that under this remote controller mode the cellular phone still can respond to critical functions. For example, it should still ring when there is an incoming phone call.

Using a cellular phone as a remote controller has many advantages. The user enjoys the convenience of having many remote controllers using one cellular phone. The user can install new remote controllers or delete old setups conveniently. A cellular phone is by far more sophisticated than prior art remote controllers so it is able to provide additional services. For example, we can use the LCD display (305) to display images to help remote control operations; we can display a picture of a prior art remote controller on the LCD panel and use arrow keys to execute all functions; we also can use the speaker (306) to provide voice instructions to help the users. The control button definitions also can be customized according to the habits of individual users. We can use voice recognition functions instead of keyboard buttons to input remote control instructions. It is also possible to update new features for a particular brand of remote controller by loading new software or providing new parameters.

Such methods in expanding the capabilities of cellular phones are convenient, but there are potential problems. When we download external software or parameters, we open the door for hackers and ill purposed software to attack the system. We may suffer the same problems that current art computer systems experience. Allowing cellular phones to be attacked by hackers or viruses can cause catastrophic results and discourage utilization of expandable functions. Furthermore, television companies may not want unauthorized people to copy/modify their software or data, but prior art methods do not provide the provider measures to protect their products once the resource is loaded by a user. We need to provide additional security features to encourage expandable cellular phone functions.

First of all, we need to have reliable identity verification methods. Fortunately, cellular phones are highly sophisticated systems with processing capability and multiple communications interfaces. Using such a powerful system, we can provide highly sophisticated identity verification methods as follow:

(1) Passwords: Passwords are well known to the art so there is no need to discuss further details.

(2) Rhythm: Rhythm is defined by time intervals and/or time durations and/or timing ratios of selected events. In other words, rhythm is a property determined by the timing of selected events. For this application, it can be defined by the time intervals between button presses and/or the length of time of buttons presses. We also can select a subset of buttons to define rhythm. For example, the system responds to three buttons and ignores all other buttons to determine rhythm. Rhythm checking combined with password checking is very effective. It is well known that computer hackers are able to crack computer passwords by repeated trial and error with intelligent guessing. Adding Rhythm checking will make it far more difficult for hackers to crack the passwords. For example, typing p-a-s-s-w-o-r-d is different from typing p-a-s-s-w-o-r-d, where the dash lines represent timing intervals between different key strokes. Due to physical differences (e.g. finger length) and individual habits, the rhythm in typing the same word is by nature different for each individual. Hackers usually type in a mechanical fashion so they tend to have problems with rhythm. In addition, the user can use a familiar tune to remember the rhythm since people are actually less likely to forget a rhythm than a password. One example of a rhythm password is to measure the time to type the password, and define “pass” as the typing time longer than a predefined time (e.g. 3 seconds between typing the first alphabet to the last alphabet). Such time requirement is very easy to remember for the user, while it will make it very difficult for a hacker who needs to try many combinations quickly. The accuracy in timing checks should be adjustable. If the timing check is too accurate, the user may need multiple tries to pass causing inconvenience. If the timing check is too loose, it is useless. We also can require more accurate timing checks for system users, while allowing looser checks for common users.

(3) Voice recognition: A cellular phone is equipped with microphone and signal processing capabilities. It is capable of executing voice recognition analysis to determine the identity of a person. Voice recognition mechanisms are well known to the art. It typically requires large storage capacity. We can implement simplified voice recognition to just a few words, or we can use cellular phone communication capabilities to link to external systems to support voice recognition using cellular phones. For example, when a user speaks to a cellular phone for voice recognition identity verification, the cellular phone can record the voice and send the recorded voice to an external high speed computer for sophisticated voice recognition checks.

(4) Finger print: The cellular phone built-in digital camera can take a picture of a fingerprint, and the CPU of a cellular phone has enough processing capability to execute fingerprint identity checks. Cellular phones certainly do not have enough storage capacity to identify a large number of fingerprints. However, verifying a few key fingerprints is enough to provide a highly reliable identification method. The cellular phone also can send the fingerprint image to external agents for sophisticated checking using cellular phone communication capabilities.

(5) Eye pattern: Similar to fingerprints, the built-in digital camera can take a picture of an eye or other characteristic body parts of a user and execute identification checks.

(6) Image recognition: The built-in digital camera can take a picture of a user and identify the user. The simplest method is to transfer the picture to a person for visual verification. Verifications by image processing can be executed by the cellular phone CPU or external computers.

(7) Signature: The built-in digital camera can take a picture of a signature and identify it. The simplest method is to transfer the signature to a person for visual verification. Verifications by image processing can be executed by the cellular phone CPU or external computers.

(8) Hardware ID: the hardware in a cellular phone can have identification information such as a serial number. We can use such hardware ID in identification verification. For example, we can check if the registered owner of a particular cellular phone is the same person who is trying to use the phone.

(9) Location: The location of a cellular phone can be determined from the cellular station which detects the cellular phone signals. Advanced cellular phone models even have global positioning system (GPS) capability. It is therefore convenient to determine the location of a cellular phone as part of the identification information. For example, if a cellular phone reports that it is trying to pay a bill to a gift shop, we can determine whether the gift shop is indeed at the right location as in the process of validating the purchase.

(10) Time: We can record the time of an event as part of a record.

(11) Logo: We can use the LCD display of a cellular phone to display a logo. For example, a user can display the logo of visa card to show a gift shop that a visa card company has approved the user's credit. Such logos should contain parts that are very difficult to duplicate. A logo does not have to be a graphic picture; we also can use sound to represent a logo.

Certainly, we can combine multiple methods for identity verifications. The above examples demonstrate that a cellular phone is by far more powerful and more reliable in providing security checks than most existing methods. A cellular phone is a powerful system that can perform sophisticated self checking. It is also a powerful communication device that can send information to external systems for additional identity verifications.

To facilitate better understanding of the present invention, a prior art computer resource management system, called “operating system” (OS) in the art, is first discussed in further detail. We will focus on the Unix operating system because the structures of other prior art operating systems are typically similar to Unix.

In prior art Unix operating system, a “user” is defined by a line stored in a system file at /etc/password. The line includes parameters such as account name, password, group name, home directory, . . . etc. Putting it in a simple way, a “user” in Unix is a name associated with a password recognized by the operating system; to use the resources in a system, a “user” starts by typing in the correct name and password to “login”. To support high priority operations, Unix defines a special user called “system user” (also called “super user” or “root user”). In Unix, a system user is basically a user who knows the system user password and login with a name called “root”. Each user can be assigned to a “group”. In Unix, many users can be assigned to the same “group” to form a “group” identity.

Unix assigns an “ownership” for each resource controlled by the system to one user. The owner can define access priority levels for three types of operations—read, write, and execute. Read operation allows a user with the right priority to view or to copy the resource. Write operation allows a user with the right priority to modify or to erase the resource. Execution operation allows a user with the right priority to use the resource as commands or instructions to control system operations. There are three access priority levels in a typical Unix operating system—(owner, group, user). Table A lists examples of Unix priority levels.

TABLE A
examples for Unix access priority levels

| o | o | o | G | G | G | U | U | U | |
|---|---|---|---|---|---|---|---|---|---|
| (r) | (w) | (x) | (r) | (w) | (x) | (r) | (w) | (x) | meanings |
| 1 | 1 | 1 | 1 | 1 | 1 | 1 | 1 | 1 | Any one can read/write/ |
| | | | | | | | | | execute |
| 1 | 1 | 0 | 0 | 0 | 0 | 0 | 0 | 0 | Only the owner can read/write |
| 1 | 0 | 0 | 1 | 0 | 0 | 1 | 0 | 0 | Read only for all users |
| 0 | 1 | 0 | 0 | 0 | 0 | 1 | 0 | 1 | user can read/execute while |
| | | | | | | | | | only owner can write |

Where o(r) is “owner read priority”, o(w) is “owner write priority”, o(x) is “owner execution priority”, G(r) is “group read priority”, G(w) is “group write priority”, G(x) is “group execution priority”, U(r) is “user read priority”, U(w) is “user write priority”, U(x) is “user execution priority”.

In the Unix operating system, when a user wants to use a resource for an operation that the user is not allowed to do, the user needs to ask the “owner” of the resource to change the priority level of the wanted resource. Otherwise, the system will not allow the user to use the resource. In this way, security is enforced. There is one exception. The system user (also called “super user” or “root user”) is extremely powerful in Unix. The system user can “overwrite” the priority levels defined by any other user. The system user can re-assign ownership of any resource and change the passwords of any user. Basically, a user who knows the system user password can do anything in the Unix operating system.

It is well known that “hackers” are able to crack such systems by guessing the passwords through intelligent trial and error. As discussed previously, a cellular phone is able to execute many identity verifications other than passwords. We can use those capabilities to make the system much more difficult for intruders to penetrate. Unlike prior art Unix system, a “user” is no longer identified by just a password. We can use many identity verification methods to check the identity of the same person. Therefore, for the same “user name” we may have different levels of identity checks. The prior art concept of a “user” as a unique name associated with a unique identity verification (password for Unix) is no longer suitable since we now have many different identity checks. One way to define the new concept of a “user” is to think of one that passes different identity verifications as a different “user” even when the “user name” can be shared. In this system, if a “user” named “USERX” passes only the password verification, that “user” is considered different than a “user” named “USERX” that passes all identity verifications. The other way is to think that a “user” can have a different “level of authority” depending on what kind of identity verification checks the “user” passes. In this system, a “user” named “USERX” that passes only the password verification has a “level of authority” of 1 while a “user” named “USERX” that passes all identity verifications could has a “level of authority” of 15. In this invention, we will use the first definition of a “user” and define a “user” as a name associated with one or a combination of identity verification(s). Identities that use the same “user name” but that pass different levels of identity verification(s) will be considered different users in our discussions.

One key problem for prior art security systems is that they are designed to protect the system; they are not designed from the viewpoint of service providers. We can use the above application of cellular phone remote controllers as an example to see this problem. More examples will be given later. Consider the situation of a television company providing a service to allow users to download remote controller software and/or parameters from its website (or from telephone systems) into cellular phones. There will be information (e.g. controller parameters or company logo) that the provider would not want any user, including the system user, to modify. There can be trade secrets or important manufacture parameters that the service provider would not want anyone, including the system user, to copy. For such applications, we should allow the service provider to define the priorities of the resource because the provider has the best expertise to define the priorities. Even the system users should not be allowed to change such priorities or ownerships. On the other hand, we also cannot give providers too much power in case their software has a virus or back door.

The solution is to implement a new identity called “guest user”. A “guest user” defined in the present invention is an identity recognized by a resource management system that has higher authority than all other users, including the system user, in defining the limitations for read and/or modify operations of a resource “owned” by the guest user. In other words, when the ownership of a resource is assigned to a guest user, the limitation on read and/or modify operations enforced by the guest user on the resource cannot be overwritten by any other user, including the system user, without the permission of the guest user.

We also can apply the same rules to more types of operations such as execution, but the essential operation for guest users are read and modify operations.

In prior art operating systems, the system knows the identity verification data for all “users”. That is not necessarily true for the “guest users” defined in the present invention. A guest user typically represents a service provider that typically serves many systems. If the data needed for identity verification of a guest user is known to many systems, the identity verification itself is no longer meaningful. For example, if a guest user uses a password that is known by millions of cellular phone users, the password has limited value. It is therefore a good practice for the resource owned by a guest user to have the capability to execute self identity verifications of the guest user. For example, the remote controller program can store the rhythm and the password of its provider without letting the system know those parameters, and execute the rhythm password checks whenever someone wants to modify it. The responsibility of identity verification of guest users may belong to resources instead of the operating system. This does not mean a guest user can get into a system without permission. The ways a “guest user” enters a system may not be the same as the “log in” procedures for common users. In the present invention, the procedure for a guest user to enter a resource management system is called “invitation”. The resource management system should have strict and secure mechanisms to “invite” a guess user. One implementation is to allow a guest user into a system only when it is invited by a user of the right authority (e.g. the system user or a user pre-assigned to have the authority to “invite” a particular list of guest users). For example, an authorized user gets to a website and “invites” a guest user to install software or provide data. Basically that means the authorized user promises the resource provider that the provider will have “guest user” priorities to control the provided resources. One also can request to be a guest user in a system, but the request must be approved by a user with the right authority. A resource provider also can refuse to provide resources if not “invited” as a guest user.

In prior art systems, when a resource is copied, the ownership of the new resource is assigned to the user who executed the copy command. We should have the option to define copy operations so that the new resource still has the same owner and the same priority levels if the resource is owned by a guest user.

One worry is that no one would be able to do anything to a file owned by a guest user even when the file is not needed or is not working correctly. The solution is to separate the conventional “write” priority. For Unix operating systems, “write” priority includes the authority to modify or to erase a file. The solution is to have a separate “erase” priority and “modify” priority, instead of a single “write” priority. The “erase” priority defined in the present invention allows a user to remove the resource from the system. For a “file”, “a file is erased” means the file no longer occupies system storage space while the original space occupied by the file is made available for others. The “modify” priority defined in the present invention allows a user to change the content of a resource while keeping the same name. For a “file”, “modify a file” means changing the file content while the file still occupies system storage area with the same file name. A system user or an authorized user should be allowed to “erase” a resource owned by a guest user. A user, including the system user, is not allowed to modify the resource unless the guest user allows it. In other words, a system user can overwrite a guest user on “erase” priority in case the system does not need the file, while the system needs to respect the guest ownership in reading and/or modifying resources owned by guest users.

Another method to limit the power of guest users is to limit resources that can be accessed by guest users. For example, we can assign part of system memory as “guest only” or “guest not allowed” areas. This method will prevent intruders from accessing or jamming critical resources.

The guest user identity is not only applicable to one user; the identity is also applicable to a group. For example, a group of engineers in a television company may all have guest user identity.

Using the above methods, we may have more sophisticated priority levels for better protection. For example, we can define 16 priority levels as listed in Table 1. There are certainly many other possible definitions.

TABLE 1
An example of priority levels

| Priority | |
|---|---|
| Level | Meaning |
| 0 | No limitation |
| 1 | Guest user, no verification, can't be overwritten by system user |
| 2 | Guest user with password verification, can't be overwritten by |
| | system user |
| 3 | Guest user with rhythm password verification, can't be over- |
| | written by system user |
| 4 | Guest user with rhythm password plus finger print verification, |
| | can't be overwritten by system user |
| 5 | Owner, no verification, can be overwritten by system user |
| 6 | Owner with password verification, can be overwritten by system |
| | user |
| 7 | Owner with rhythm password verification, can be overwritten by |
| | system user |
| 8 | Owner with rhythm password plus finger print verification, can |
| | be overwritten by system user |
| 9 | Any user with password verification |
| a | Any user with rhythm password verification |
| b | Any user with rhythm password plus finger print verification |
| c | System user with password verification |
| d | System user with rhythm password verification |
| e | System user with rhythm password plus finger print verification |
| f | No one can access under any condition |

The example in Table 1 only uses three identity verification methods (password, rhythm, and finger print). We can certainly use many other identity verification methods in defining the priority levels. Prior art computer security systems do not have a priority level that allows no one to access data. We believe this priority level (level ‘f’ in Table 1) is important to prevent accidental operations activated by careless users.

We can assign different priority levels for different operations of a resource—erase, execution, read, and modify. Read operation allows a user with the right priority to view or copy the resource. Erase operation allows a user with the right priority to erase the whole resource. Modify operation allows a user with the right priority to change parts of the resource. Execution operation allows a user with the right priority to use the resource as commands or instructions. Examples of priority level assignments are shown in Table 2.

TABLE 2
Examples of priority levels

| E | X | R | M | Meaning |
|---|---|---|---|---|
| 0 | 0 | 0 | 0 | Any one can erase, execute, read, or modify the file |
| 6 | 5 | 6 | 3 | Only owner with password verification can erase or |
| | | | | read the resource; only owner can execute the re- |
| | | | | source; only guest user with rhythm password verifica- |
| | | | | tion can modify the resource. |
| 9 | 9 | 9 | c | Any one with password verification can erase, execute, |
| | | | | or read the resource; only system user with password |
| | | | | verification can modify the resource. |
| e | 7 | e | 4 | Only system user verified by rhythm password plus |
| | | | | finger print can erase or read the resource; only owner |
| | | | | verified by rhythm password can execute the resource; |
| | | | | only a guest user verified by rhythm password plus |
| | | | | finger print can modify the code. |
| f | 0 | f | f | No one can erase, read, or modify the file; any one |
| | | | | can execute the file. |

Many other methods of defining security levels will be developed upon disclosure of the present invention. Such security features make it more difficult for hackers to attack resources in the system, and offer more protection to software/data providers.

Beside identity protection, we need to improve protection against viruses. In the case of viruses, a file with “execution” priority is more dangerous than other files. The most common prior art method against viruses are anti-virus programs that scan through files looking for patterns of known viruses. However, existing anti-virus programs take up a lot of storage space, require long periods of time to scan the files, and cost a lot to keep updated. Installing prior art anti-virus programs in a cellular phone is therefore not cost effective.

One solution is to put the responsibility on the shoulders of software providers instead of asking every software user to have anti-virus programs. FIG. 3(e) is a flow chart for such sterilized-by-provider (SBP) methods. The providers take the responsibility of running anti-virus methods to sterilize resources they want to release. The provider may add additional protections. A qualification record (QR) is attached to sterilized resources to provide information such as the types of anti-virus measures that have been executed, identity of providers, size of the program, check sum of the program, . . . etc. The qualification record (QR) can include information designed to prevent ill purposed modifications to the software. Typical methods are “check sum” methods associated with file size. When a user receives the resource, a QR decode mechanism is activated to decode QR, and provide warnings if problems (such as check sum errors) are found. Based on the results of the above qualification methods, the receiver determines the proper priority level of the software. For example, a file without SBP qualification should not have “executable” priority level; a file that has SBP qualification but fails self check should be reported and deleted; only a highly qualified file can have “executable” priority.

The SBP protection method has many advantages. A software program can be distributed to millions of users. It is by far more cost effective to ask the provider to sterilize the software, instead of causing millions of users to run different anti-virus programs. Instead of maintaining large anti-virus programs for millions of users, individual users only need small software programs that can decode the QR attached to SBP protected software. The software provider typically has more resources and better expertise to sterilize the software than individual users. In case a sneaky virus still breaks through SBP protection, it will be much easier to catch the intruder because we only need to trace a few providers instead of tracing millions of users. The key to success for SBP methods is the effectiveness of QR. QR should be difficult to modify (e.g. require high difficulty identity check) and convenient to decode.

Another solution is for the users or the system to maintain a “trusted provider list” (TPL) in terms of internet addresses, email addresses, and identities checked by identity verification methods, and other identifications. FIG. 3(f) is a flow chart for TPL methods. The user maintains a TPL. When a resource is in the process of being sent to the system, the user checks the TPL and assigns proper priority levels to the resource. For example, if the provider is not on TPL, a warning is sent to the user asking for permission to assign proper priority levels to the resource. If the provider is on TPL, the priority levels according to the records in TPL are assigned.

We certainly can combine “trusted provider list” method with “sterilized-by-provider” to have double protection against ill purposed software.

The above methods are useful to prevent an ill purposed program from being executed, but they are helpless once a virus is executed. A method to stop ill purposed programs after they are executed is to assign priority levels to define which resource is available to an executable software program. In this way, an ill purposed operation can be stopped by the resource management system at run time. Table 3 lists an example of such resource access priority level (RAPL).

TABLE 3
An example for RAPL

| Level | Meaning |
|---|---|
| 0 | Can not use the resource under any condition |
| 1 | Only can use the resource within a specified range |
| 2 | Can not use the resource within a specified range |
| 3 | Only can input from the resource within a specified range |
| 4 | Can not input form the resource within a specified range |
| 5 | Only can output to the resource within a specified range |
| 6 | Can not output to the resource within a specified range |
| 7 | Access the resource without limitation |

There are many other ways to define RAPL besides the example shown in Table 3. We may need a lookup table to define the range of partial accesses. For each resource in the system, we can have a RAPL assigned for each executable software program. Table 4 lists a few examples for the application of RAPL.

TABLE 4
RAPL application examples

| | mem- | | inter- | dis- | Key | |
|---|---|---|---|---|---|---|
| resource | ory | phone | net | play | board | meanings |
| RAPL | 1 | 5 | 0 | 6 | 7 | This application software |
| | | | | | | can only read/write a |
| | | | | | | portion of the system |
| | | | | | | memory, can only make |
| | | | | | | phone calls to a limited |
| | | | | | | list of numbers, cannot |
| | | | | | | use internet at any time, |
| | | | | | | can only display image at |
| | | | | | | specific conditions, and |
| | | | | | | has no limitations in |
| | | | | | | response to the keyboard. |
| RAPL | 0 | 0 | 7 | 7 | 0 | This application software |
| | | | | | | can access the internet |
| | | | | | | and system display with- |
| | | | | | | out limitation but it can- |
| | | | | | | not use the phone call or |
| | | | | | | read/write to system |
| | | | | | | memory; no response to |
| | | | | | | keyboard. |
| RAPL | 0 | 0 | 0 | 0 | 0 | This software cannot do |
| | | | | | | anything. This state is |
| | | | | | | useful when the software |
| | | | | | | is just loaded from an ex- |
| | | | | | | ternal source. A user may |
| | | | | | | change its RAPL to make |
| | | | | | | it useful at proper time. |
| RAPL | 7 | 7 | 7 | 7 | 7 | This software has no |
| | | | | | | limitation in using |
| | | | | | | resources. |

For example, the application software for a particular brand of a TV remote controller should have the priority to input from keypad and output to IR device, while the system should check its RAPL and allow it to access nothing else. If the remote controller software is trying to make phone calls, the system should know there may be problems; the system should block the activities and/or provide warnings. Typically, the CPU should execute RAPL checks. Sometime, a separate logic can execute RAPL checks. Another useful method is to place access level checks at the resource control circuits (e.g. RF interface circuits, auto interface logic circuits, . . . etc). It is also possible to assign different RAPL levels for different functions in the same executable file. For example, when a program calls a function or a subroutine that is used to make a phone call, that part of software can have access to the RF interface while all other parts do not have the same priority level. More applications of RAPL will be discussed later. A “resource” defined in RAPL method also can be a particular software program or a partition of a memory device.

It is true that even with all the above security methods, it is still possible for intruders to break through. However, these methods will make cellular phone systems more difficult to be broken. In case security is broken, it will be easier to catch the intruder.

FIG. 3(g) shows the flow chart describing one example of cellular phone software installation procedures. The first step is for a user to log in to the system with proper verification. The user can choose different levels of identity checks to execute different tasks at different priority levels. If the user is able to pass the identity check and log in the system, the system would know the identity of the user. The user can select sources (a website, a phone number, another user, . . . etc) and make connections. At this stage, the source may request identity checks to verify the identity of the user. In the mean time, the user also can execute verification on the source using SBP, TPL, or other methods. The source may request to install the software as a “guest user” at this stage. The user also may “invite” the provider as a “guest user”. After all those verifications are done, the system determines the ownership, the priority levels, and RAPL levels of the resource. The software can be installed after the above preparations. The installed files also can have a relatively safe initial RAPL (e.g. cannot do anything). A user passed proper identity check can re-assign the priority levels and RAPL of the file later.

It is often desirable to use built-in software installed by the cellular phone manufacturer. This method is more secure because the manufacturer has excellent control over the cellular phone system. The only difficulty is to convince the manufacturer to put in desired software as built-in features. FIG. 3(h) is a flow chart for the procedures when the manufacturer has already made the desired software (e.g. the remote controller software) as part of their cellular phone built-in features. If the parameters are provided by external sources, we may still need to protect the provided parameters. The procedures and protection features are similar to those of software installation procedures in FIG. 3(g) except that we only need to load parameters instead of whole software. If the parameters are provided by the cellular phone user, the procedure and protection features can be simpler.

While specific embodiments of the invention have been illustrated and described herein, it is realized that other modifications and changes will occur to those skilled in the art. There are many ways to define priority levels and ownerships. A “guest user” identity of the present invention may be divided into several different types of mechanisms and implemented in different ways. Details of resource management methods can vary with different implementations. The resource management system of the present invention does not have to be an operating system. The resource management system of the present invention can be part of the operating system, the same as the operating system, separated from the operating system, or includes the operating system. For example, a resource management system of the present invention can be a software program or a built-in function that enforces security features such as the “guest user” identity within an existing operating system. TV remote controllers were discussed in the above example, but cellular phones can support almost any kind of prior art remote controllers (VCR, DVD, car keys, garage door openers, door locks, appliance switches, etc).

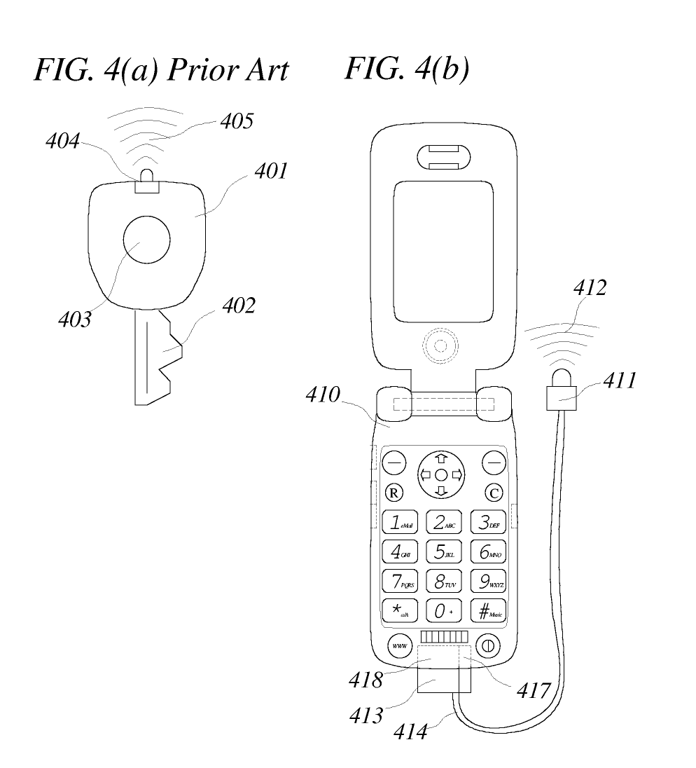

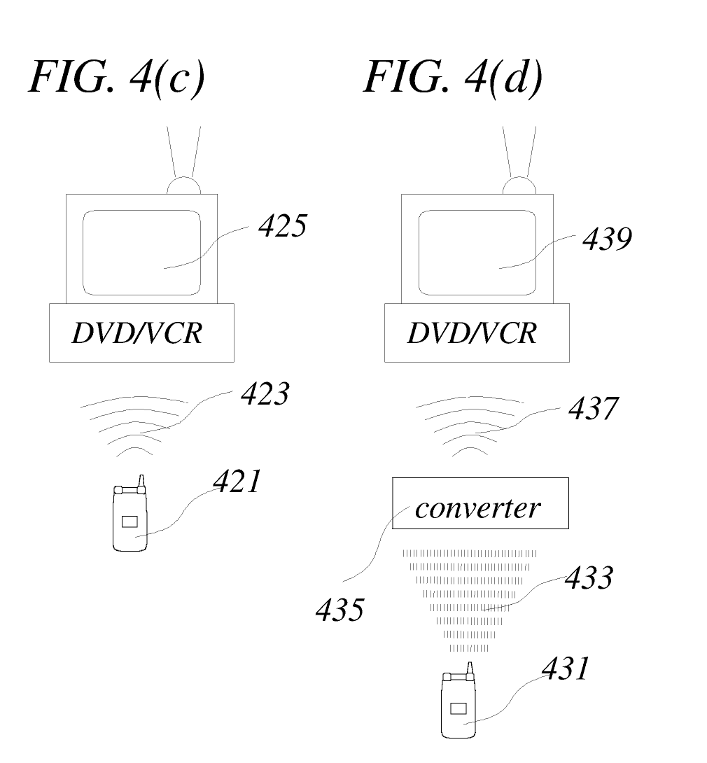

FIG. 4(a) illustrates the structure of a prior art remote control key (401). It has a mechanical key (402) that operates as common keys do. It also has an IR emitter (404) that can transmit IR signals (405) to open or close a lock when a button (403) is pressed. The format of the remote control signals can be obtained by using an IR sensor to record the IR signals (404) from an existing key. When the cellular phone is set to remote control key mode, the cellular phone can use its IR device (301) to send out the same IR signals upon pressing certain buttons. The functions of remote control keys are relatively simple compared to the functions of TV remote controllers, but security requirements are greater. The sophisticated identity check functions discussed above can provide additional security when a cellular phone is used as remote control keys. For example, when the cellular phone is used as a car key, it can ask for a rhythm password before it is activated. The cellular phone is fully capable of executing more sophisticated security checks such as voice recognition or finger print verification. When a prior art key is stolen, the thief can steal the owner's car or open the owner's doors easily. When a cellular phone is stolen, it will be much more difficult for the thief to steal cars or open doors because the thief will need to pass identity verifications.

The cellular phone (300) in FIG. 3(b) requires modifying hardware to add the IR emitter (301). Sometimes the industry has strong barriers in changing existing hardware. A method to overcome such barriers is to provide an IR emitter attachment as shown in FIG. 4(b). The cellular phone (410) in FIG. 4(b) is identical to the typical prior art cellular phone shown in FIG. 1(a). An IR device (411) is connected to the cellular phone (410) through an interface port (413) plugged into the headset interface (418) and the battery charger port (417) of the cellular phone. Electrical wires (414) provide electrical connections between the interface port (413) and the IR device (411). For this example, the cellular phone (410) can control the IR signals (412) emitted from the IR device (411) using similar signals and the interface used to control headsets. The cellular phone is already equipped with sophisticated methods to process audio signals. It makes sense to use similar methods and a similar interface to control IR signals. For example, we can control the IR device (411) using the control mechanisms used when the cellular phone is controlling a headset. The charger input port (417) can provide power connections to the IR device; we also have the option not to use this power connection. Certainly, the external IR emitter also can connect to the cellular phone using other types of interfaces.

While specific embodiments of the invention have been illustrated and described herein, it is realized that other modifications and changes will occur to those skilled in the art. For example, the above examples use IR signals to transfer remote control signals. It will be equally convenient to use other wireless signals such as RF signals, sound, or visible light signals to serve the same purpose. In many ways, it is more convenient to use signal sources that typical cellular phones already have. For example, FIG. 4(c) illustrates a method using a cellular phone (421) that emits remote control signals (423) to control appliances (425) such as televisions, DVD players, VCRs or other appliances. The remote control signals (423) emitted by the cellular phone (421) can be infrared, visible light, sound, or RF signals. However, that means the appliances (405) also need to have proper detectors to receive the emitted remote control signals (403). Traditionally, TV remote controllers use IR signals, so we will need to build new receivers installed in the appliances in order to receive different types of remote control signals. One method to solve this compatibility problem is to use a signal converter (435) as illustrated in FIG. 4(d). The cellular phone (431) emits RF signals (433) or other types of signals to the signal converter (435). The converter (435) translates the cellular phone signals (433) into IR signals (437) or other types of signals that are compatible with existing appliances (439). With the help of the signal converter (435), we no longer need to modify the structures of the appliances (439) or the cellular phone (431). The cellular phone signal (433) and the converted signal (437) also can be the same type of signals (e.g. both are IR signals); under that situation, the converter (435) behaves as an amplifier or a translator.

While specific embodiments of the invention have been illustrated and described herein, it is realized that other modifications and changes will occur to those skilled in the art. In FIG. 3(d), we discussed methods to allow external systems such as internet systems, telephone systems, PDA, and computers to install software or transfer data into a cellular phone. Besides those listed systems, there are many other methods to transfer data into cellular phone system storage devices. One useful example is direct copying from one cellular phone to another.

Prior art cellular phones always go through cellular stations or internet systems to communicate with other devices. Those communication methods are powerful but dangerous. One of the most effective security enhancement methods is simplification. For many situations, it is desirable that a cellular phone can output data directly without the help of cellular stations or networking devices; the capability to exchange data directly between cellular phones is especially useful. When the communication is one-to-one between two cellular phones, the communication is by nature more secure. If anything goes wrong, we know who is responsible.

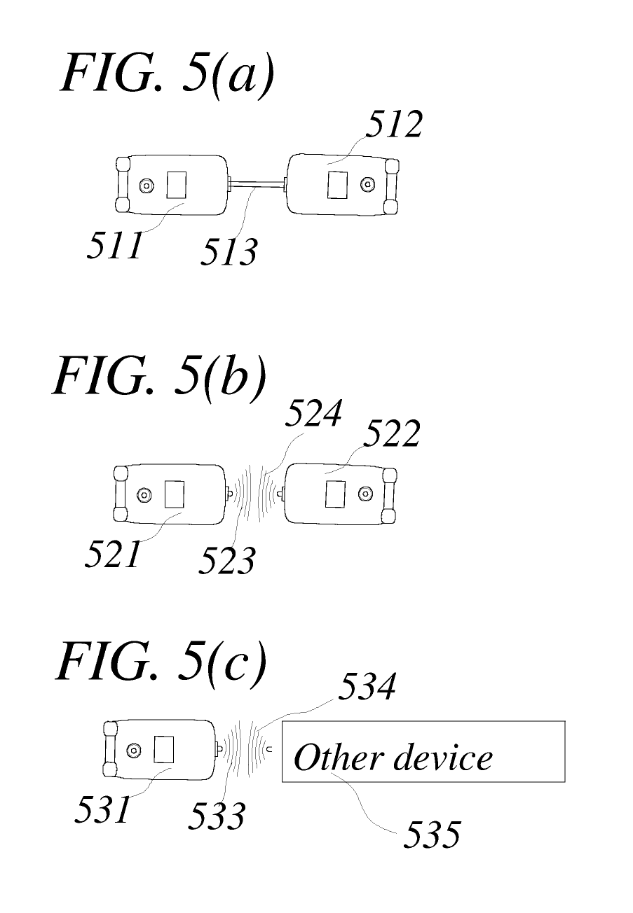

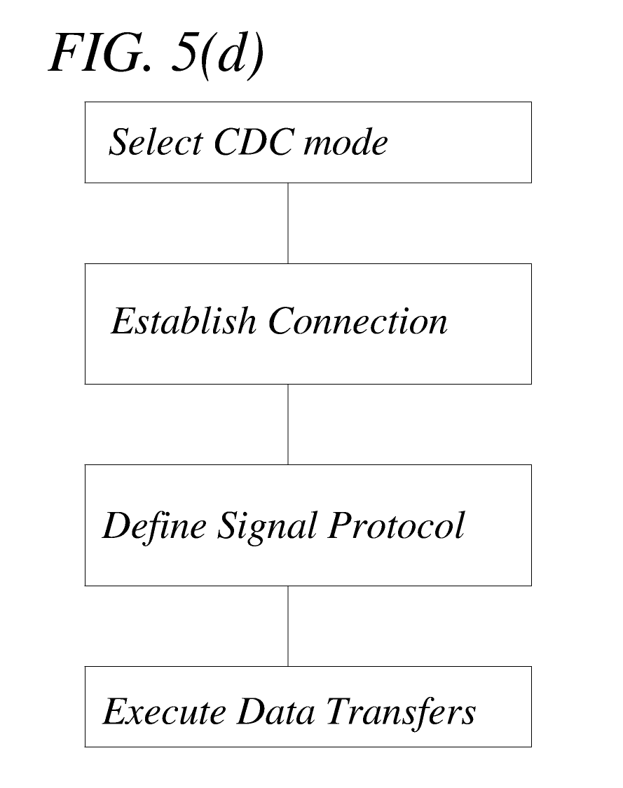

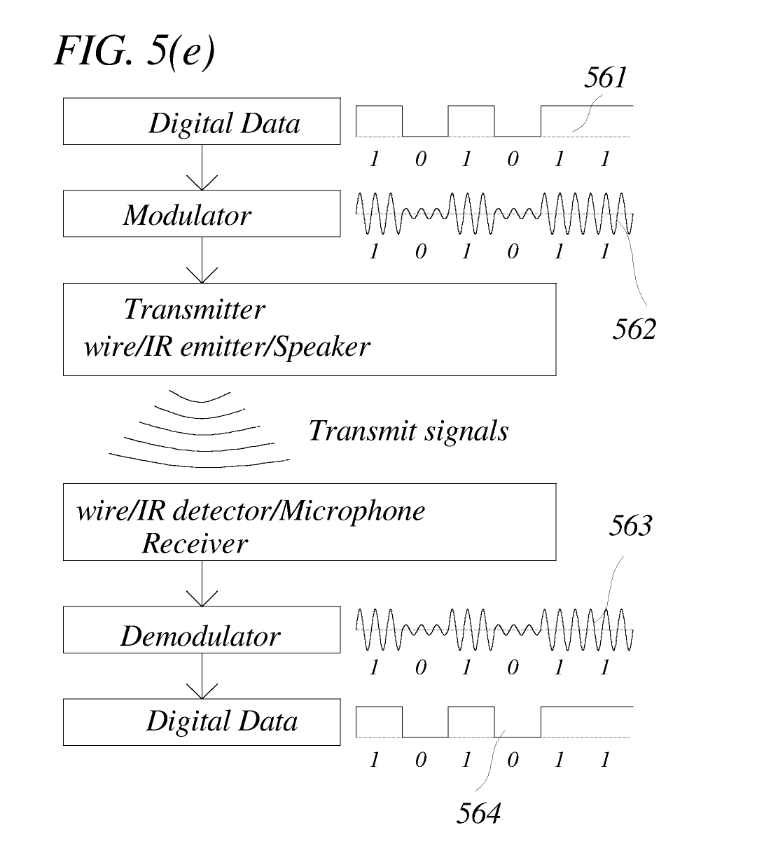

FIGS. 5(a-e) illustrate cellular phone direct communication (CDC) methods of the present invention. By definition, CDC communication is one-to-one communication directly between two cellular phones without the help of external systems such as cellular stations or internet. FIG. 5(a) shows an example of cellular phone direct communication (CDC) between two cellular phones (511, 512) through a wire (513). A wired connection provides high data transfer speed, simple control, and security. It is less convenient because the users need to carry a wire that is compatible with both cellular phones. FIG. 5(b) shows another CDC example in which two nearby cellular phones (521, 522) communicate using wireless signals such as IR, visible light, or sound signals (523, 524). Such communication methods are convenient and secure. Similar one-to-one communication methods are certainly applicable for direct data communication between a cellular phone (531) and other types of devices such as a computer (535), as illustrated in FIG. 5(c). The signals (533, 534) used in FIG. 5(c) can follow the same mechanism as those in FIG. 5(b).

The details in signal transfer protocols for CDC can be very complex. Fortunately, prior art networking systems have developed a wide variety of signal transfer protocols. Many of those existing signal transfer systems are applicable for cellular phones. For example, the wired signal transfer in FIG. 5(a) can follow Ethernet protocols or USB standards with modifications to reduce power consumption. The IR signal communication can follow similar methods used for Blackberry devices or remote controllers. Data communication methods using sound waves have been discussed in U.S. patent application Ser. No. 10/896,354. We certainly can develop new protocols optimized for CDC communications.

FIG. 5(d) is a simplified flow chart depicting procedures for CDC data transfers. A user can use the mode select options to set a cellular phone into CDC mode. Once in CDC mode, the cellular phone can request a connection to the other cellular phone, while looking for requests from the other phone. When another phone responds to a request, we may need to execute identify verification to establish a link. A user also can approve the request from another phone. The phones need to agree upon the signal transfer protocols. Then we should be able to start communication. In a preferred embodiment, the file systems of linked cellular phones should appear to be in the same file system controlled by identity verifications and priority levels, allowing flexible but secure data sharing. In CDC mode, the cellular phone may respond to high priority functions such as ringing to indicate an incoming phone call.

Methods developed for current art communication systems typically divide into seven levels of communication protocols. As soon as a cellular phone can support the lowest level protocol at the physical level, we can use cellular phones to support most existing communication systems without changing the higher level protocols. FIG. 5(e) illustrates the physical level CDC signal transfer. A modulator converts Digital data (561) into modulated signals (562) using cellular phone signal carriers such as wire, IR, or sound. A receiver (e.g. another cellular phone or other types of devices such as a computer) uses a proper detector (e.g. wire, IR detector, or microphone) to receive the transmitted signals. A demodulator converts the received signals (563) into digital data (564) for signal processing. The modulation can be amplitude modulation (AM), frequency modulation (FM), or any other modulation known to the art of signal modulations. Wired communication may not need modulation procedures.

CDC data transfer is convenient for many applications. For example, instead of exchanging business cards, businessmen can exchange information (e.g. name, company, email address, phone number, fax number, address, title, . . . ) using CDC in a split second because all the information is organized by cellular phone software. We also can have the flexibility to exchange a subset of information (e.g. only name and phone number) using CDC. For another example, you have a cellular phone that has been set up in the best way to serve your needs; the address book in the cellular phone has all the information of your friends; the alarm clock is set to wake you up at the right time; the remote control modes have been set up for your favorite TV sets, DVD players, car keys, and door keys; and all the identity checking parameters such as passwords, rhythm, and fingerprinting have been set properly. Now you want to change to a new cellular phone. Instead of going through all the trouble to reset all those parameters, you can use CDC mode to copy parameters from the old cellular phone into the new cellular phone. Linking to a computer while in CDC mode, the phone can store all its parameters and programs in a backup file on the computer. In case your cellular phone is lost or damaged, you can copy the backup database from a computer back to a new cellular phone using CDC mode. If you found your friend setup his cellular phone in several ways that you really like, you can copy those configurations you like from your friend's cellular phone to your cellular phone using CDC.

While specific embodiments of the invention have been illustrated and described herein, it is realized that other modifications and changes will occur to those skilled in the art. FIGS. 3(d-g), Tables 1-4, and associated discussions show that a cellular phone is capable of executing highly sophisticated identity verification checks. These identity checking capabilities are not only useful for supporting software installations for a remote controller. A cellular phone equipped with identity checking mode is fully capable of supporting many important applications. For example, we can use a cellular phone to serve the functions of credit cards.

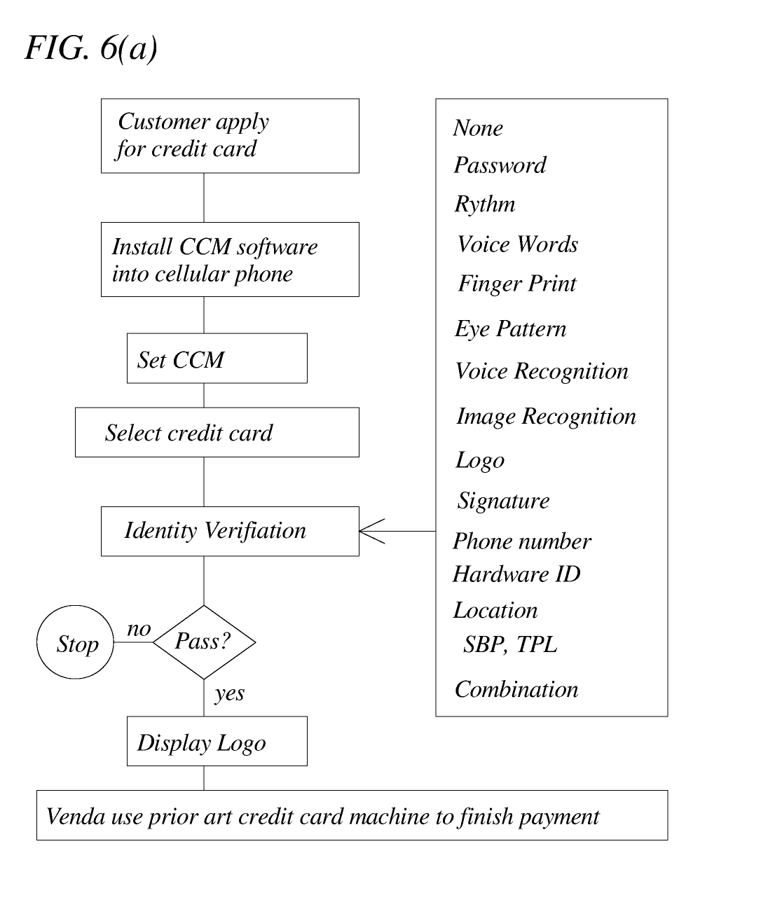

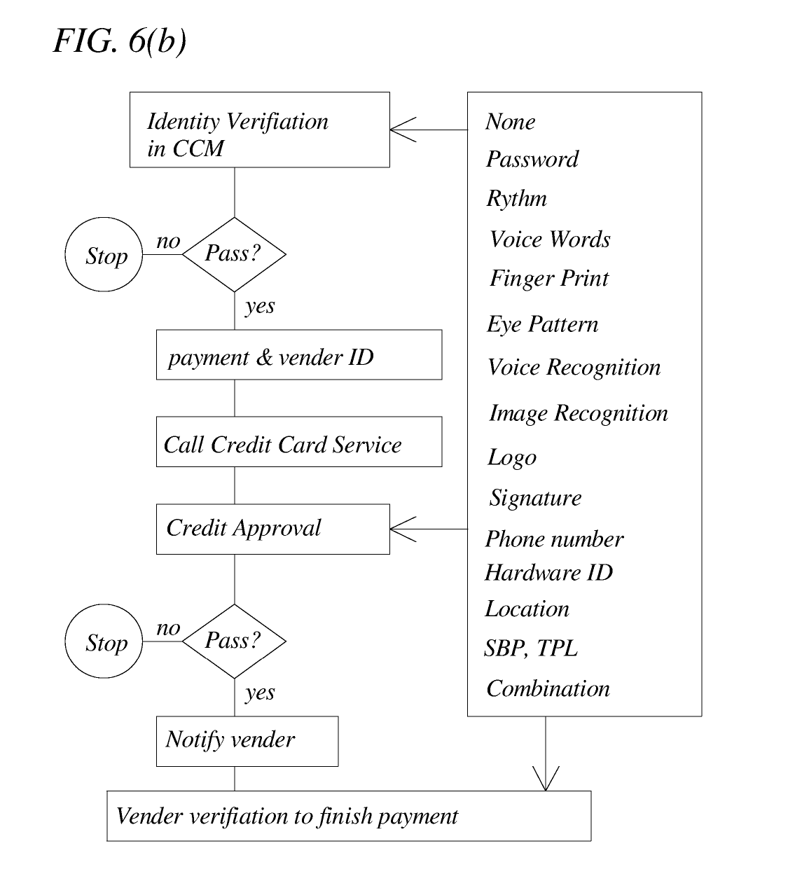

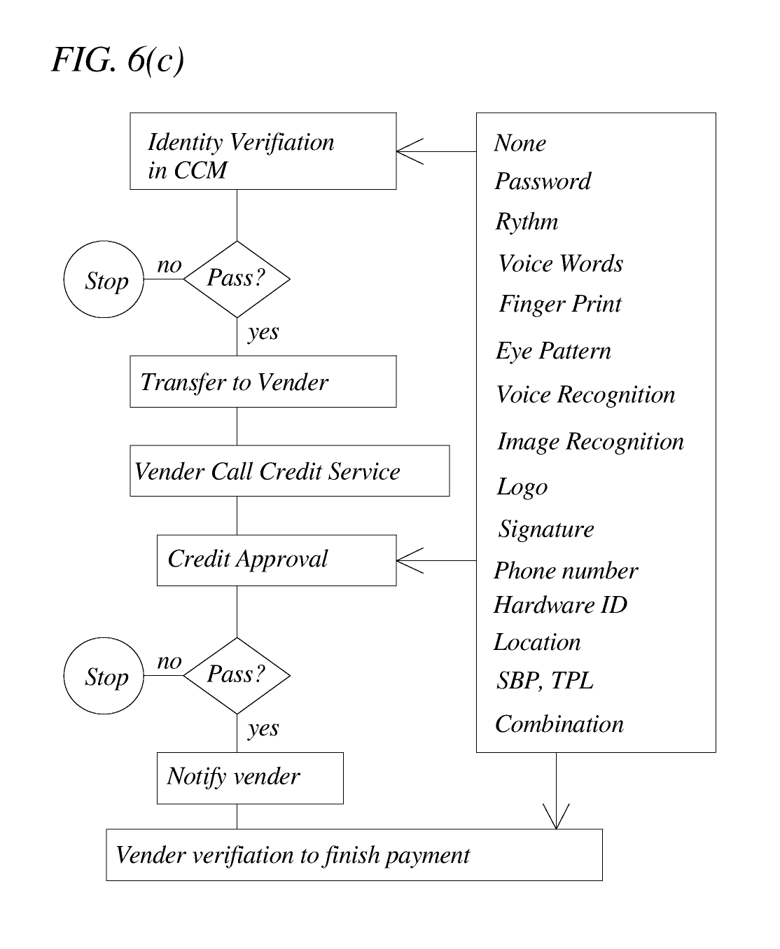

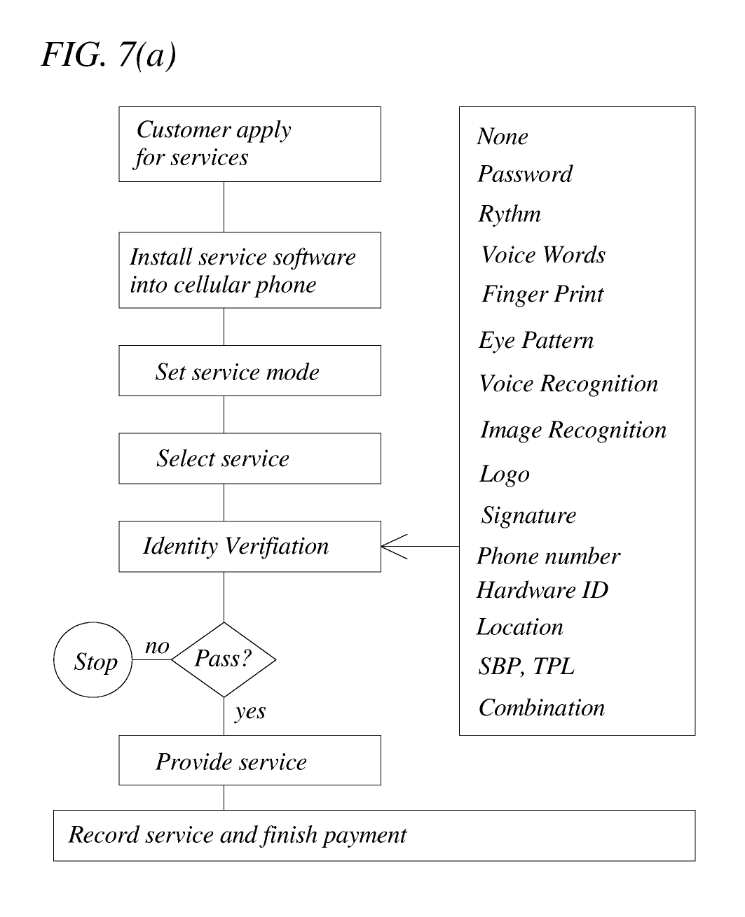

FIG. 6(a) is a flow chart describing one method of using cellular phones to support the functions of credit cards. A user applies for approval from a credit card company. Instead of (or in addition to) issuing a plastic card with a magnetic stripe, the credit card company installs credit card mode (CCM) software into the cellular phone of the applicant, or activates such mode from a built-in function provided by the cellular phone manufacturer. This procedure is very important. The installation procedures are preferred to be protected by security methods of the present invention. For example, the CCM files can have priority levels that do not allow anyone but the credit card company to modify its contents and allow no one but the correct user to execute the software. In this way, venders can trust that the cellular phone user is indeed the right card holder approved by a credit card company. If the software can be modified by the user, this method has no credibility. Although a cellular phone is able to execute reliable identity verification methods, all those verification methods would be meaningless if the priority of the CCM software is not set properly. For example, if a user can change the identity data, the identity checks would become meaningless. We also should consider the situation when critical data are changed by accident or by ill purposed intruders. The methods of assigning “guest user” identity to the credit card company are therefore very useful. Since the cellular phone owner cannot alter software protected by the “guest user” identity, the cellular phone owner will have credibility as an approved card holder. The credit card company does not have to install the software physically. The cellular phone user can download the parameters or files from a website or a phone line into the cellular phone through the “invitation” mechanism of the present invention; as soon as the installed software is assigned with the right protection level (e.g. with “guest user” identity assigned to credit card company) at operation time, this method has the needed credibility. We can assign proper identity verification checks such as a rhythm password to protect credit card transactions. For large payments, we can assign more sophisticated checks such as fingerprint checks or transferring the picture of the customer for visual identification. Many identification methods have been discussed previously.

The CCM software can execute credit card transactions in many ways. For the example in FIG. 6(a), the customer sets a cellular phone into CCM, selects one type of credit card, and executes identity verification checks. When the identity verification passes, the cellular phone displays the logo of the credit car on the LCD panel with information such as card number, signature, and a picture of the owner. In addition, it also can send out logo music from the microphone to make the logo more convincing. Viewing the cellular phone displaying the logo, the vender can know that the customer has been qualified by the credit card company. The prerequisite for this trust is the assurance that the installed credit card software or credit card parameters are protected with the right security features. The vender can copy the credit card number and use existing credit card machines to process the payment.

The method in FIG. 6(a) is convenient for the user. A user can carry many CCM software issued by many credit card companies in one cellular phone. It is equivalent to carrying many credit cards without occupying any wallet space. The cellular phone identity verifications are by far more reliable than a card with a magnetic stripe and a signature. It is well known that credit card thieves can remove the signature on a stolen credit card and put on their own signatures. A thief that steals a cellular phone will have much more difficulty using CCM. We can even program the cellular phone to send out special signals when someone other then the user is trying to use CCM. Policemen can follow the signal to catch the thief. The vender has the advantage of knowing that the customer is less likely to be a credit card thief. The credit card company saves cost because installing software is lower cost than manufacturing a plastic credit card. It will be easier to re-install a stolen credit card because all we need to do is to re-install the CCM software into a cellular phone. The installation procedures can go through telephone systems or internet systems. The credit card company can allow the customer to download the approved file from the internet using security protection methods of the present invention. All these conveniences may make the cellular phone credit card become the favorite choice of customers, which will bring in more profit for the credit card company. One convenient condition is the credit card company and the cellular phone company belonging to the same company. We can have the best security features if the credit card company also designs the cellular phone.

There are many other methods to use a cellular phone to serve the functions of credit cards. FIG. 6(b) is a flow chart describing another method. We assume that the customer has been approved by a credit card company and CCM software has been installed into a cellular phone with the right priority levels. The customer sets the cellular phone into CCM function, selects one type of credit card, and executes identity checks. When the identity check is passed, the customer enters information such as payment amount and vender ID and then notifies the credit card company through phone, internet, or other communication systems (CCM software can make the notification). The credit card company receives the notification, verifies the identity of the customer, approves the purchase, and notifies the vender. To notify the vender, the credit card company can send signals to print out a receipt on the vender's credit card machine in the same ways as prior art credit card system. The credit card company also can make a phone call or send an email.

Compared to the method in FIG. 6(a), the method in FIG. 6(b) has better security checking capability. The customer needs to do more work, while the vender has less work. Using the location tracking capability of the cellular phone, this method allows the credit card company to record location and time of the transaction as additional information to verify the payment.

FIG. 6(c) is a flow chart for another method that is more convenient for the customer. We assume that the customer has been approved by a credit card company and that CCM software has been installed in a cellular phone with the right priority level. The customer sets the cellular phone to CCM mode, selects one type of credit card, and executes identity verifications. When the identity is verified, the customer uses one of the methods illustrated in FIGS. 5(a-c) to send information to the vender's cellular phone or credit card machine. If the vender has enough trust in the customer, the vender can bypass all the above procedures and ask the customer to input identity information into the vender's cellular phone to activate CCM activities. The vender's cellular phone or credit card machine calls the credit card company with information such as customer identification, vender identification, and payment amount. The credit card company may ask for identity checks for the vender and/or the customer at this stage. When the identity checks and credit checks pass, the credit card company notifies the vender that the payment is approved. To notify the vender, the credit card company can send signals to print out a receipt on the vender's credit card machine in the same ways as prior art credit card system, or tell the vender directly by phone or email.

Compared to the method in FIG. 6(b), the method in FIG. 6(c) is more convenient for the customer. Using the location tracking capability of cellular phones, this method allows the credit card company to record location and time of the transaction as additional information to verify the payment. The credit card company also has the option to verify the identities of both the vender and the customer.

While specific embodiments of the invention have been illustrated and described herein, it is realized that other modifications and changes will occur to those skilled in the art. Besides the methods described in FIGS. 6(a-c), there are many other possibilities to use cellular phones to serve the functions of credit cards. Almost all the methods will be far better than prior art plastic cards. Instead of installing software or activating an existing option, the credit company also can issue hardware attached to cellular phones. Similar methods certainly can support the functions of a charge card or a check. The cellular phone identity verification capability can replace the functions of most of the prior art cards we carry in our wallets.

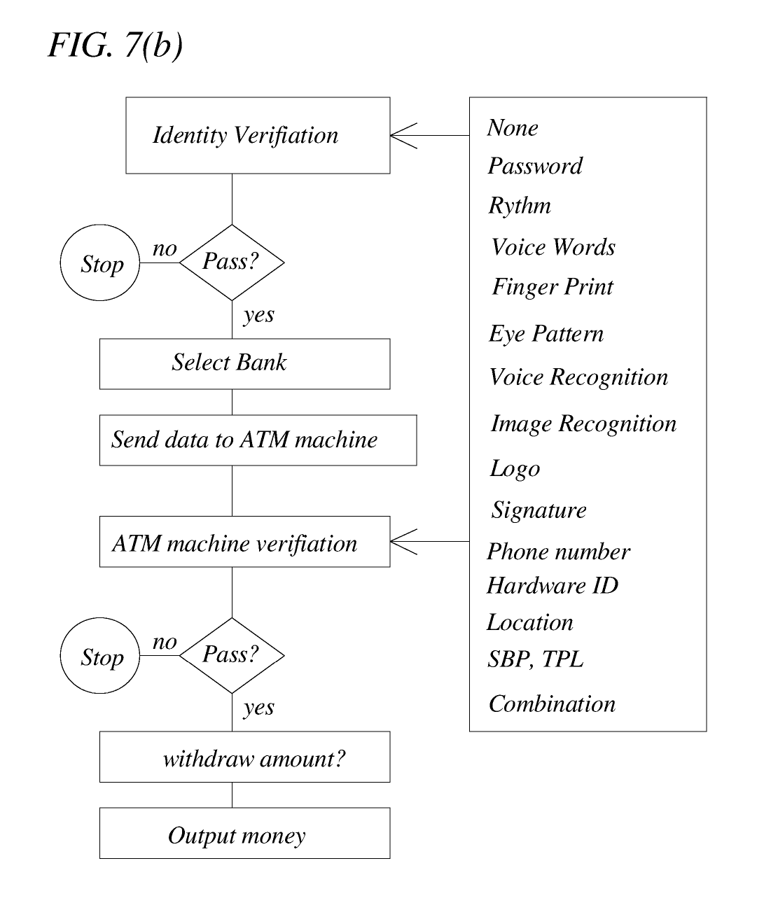

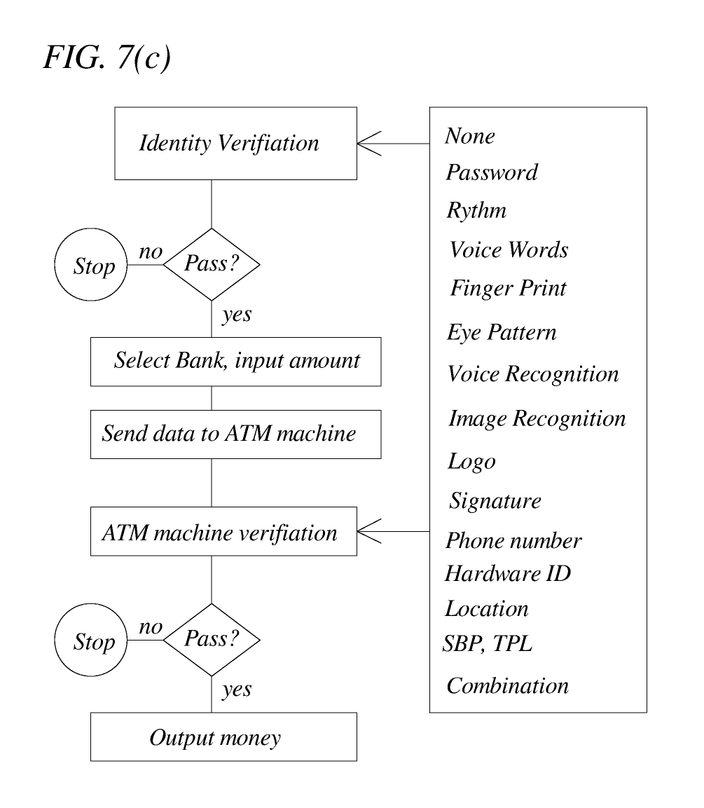

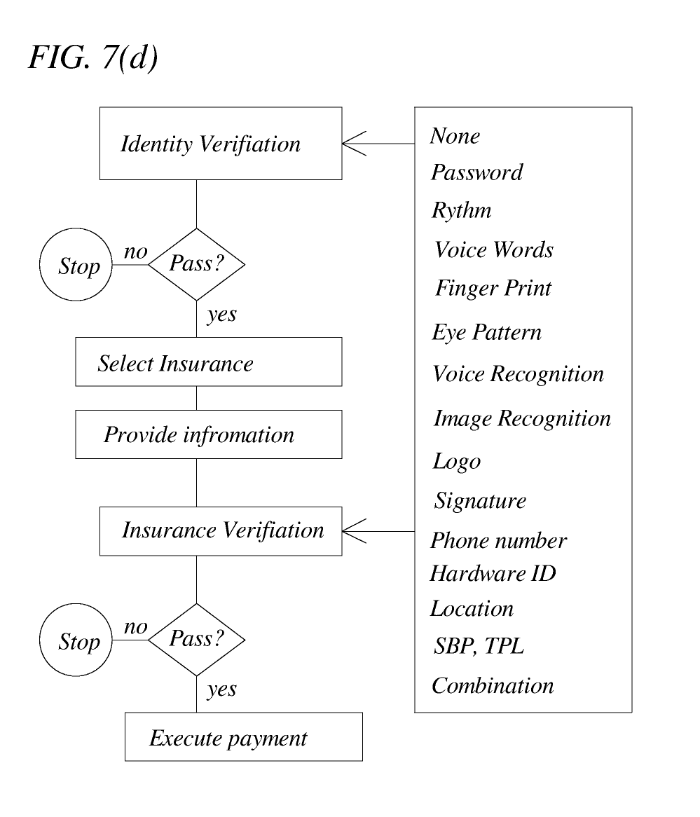

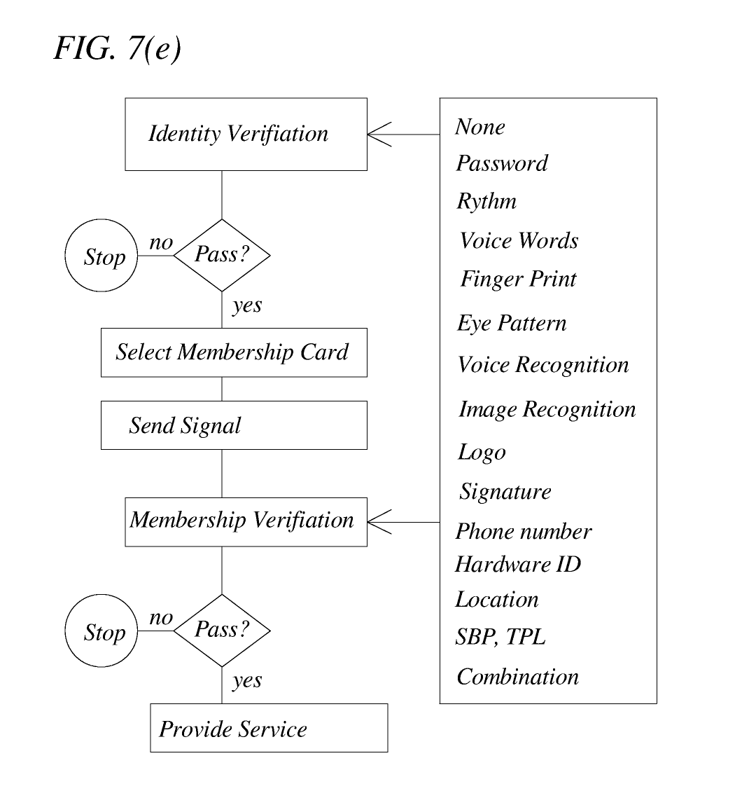

FIG. 7(a) shows the flow chart for a generalized example of the method to use a cellular phone as a personal identification device for acquiring services. After a customer applies for services, the service provider approves the application by installing service software into the customer cellular phone using security methods of the present invention. This service software should have proper priority. For example, it allows no one but the service provider to modify the files, while allowing no one but the customer to execute the service mode. We can allow the service provider to have enough security by assigning the service provider with “guest user” identity of the present invention. To acquire a service, the customer sets his cellular phone to service mode and selects the service. After the customer is able to pass the identity verification, the service provider can provide the service and record the transactions.

FIG. 7(b) is a flow chart for an example of the method of using a cellular phone to serve the functions of an automatic teller machine (ATM) card. We assume that a bank has installed an ATM mode in the user's cellular phone. The user can execute self verification so that the cellular phone knows the right owner is using its service. After the self verification has passed, the user can select the proper bank in case he carries more than one ATM card in his cellular phone database. The cellular phone sends signals to the ATM machine using the method illustrated in FIG. 5(c), assuming that the ATM machine is equipped with detectors that can accept voice/IR/wired signals from cellular phone, and process the data accordingly. Voice, IR, or wired signals have better security than RF signals for this application. The following procedures can be fully compatible with existing ATM machines. The ATM machine may require another level of verification such as asking for a password. If the user passes ATM verification procedures, the user can continue to execute normal ATM services such as withdrawing cash from the machine.

Using a cellular phone as an ATM card has the advantage that cellular phone built-in verifications are by far more reliable than a plastic card with a magnetic stripe. The user also can carry many ATM cards in a single cellular phone. The cellular phone also can take over most of the functions of conventional ATM machines. For example, FIG. 7(c) shows a flow chart for another example of the method of using a cellular phone to serve the functions of an automatic teller machine (ATM) card. After self verification has passed, the user continues to execute ATM functions such as inputting an amount of money on the cellular phone. When the cellular phone sends signals to ATM machine using a method illustrated in FIG. 5(d), most of the procedures have been finished. The ATM machine may require another level of verification such as asking for a password. If the user passes ATM verification procedures, the ATM delivers the transaction.

FIG. 7(d) is a flow chart describing an example of the method of using cellular phones to serve the functions of insurance cards. The same methods are applicable to medical, dental, automobile, life, and other insurances. We assume that the insurance provider has activated insurance card mode in the user's cellular phone using security methods of the present invention. The user can execute self verification so that the cellular phone knows the right owner is using its service. For this application, self verification is typically less important because there are fewer reasons for a thief to use another person's insurance card. For the same reason, the cellular phone may be just a device that carries insurance information installed by the user instead of the insurance company. After self verification passes, the user can select the proper insurance plan among many insurance plans carried by the cellular phone. For cases such as routine doctor visits, all we need to do is display information such as insurance number, name, and insurance company on the LCD panel for the secretary to finish the paperwork. For more complex conditions, the cellular phone can notify insurance companies for more information. The insurance company may ask for further verifications at this stage.

There is really no point to carry many insurance cards in a wallet because a single cellular phone can easily support the functions of many insurance cards. In addition, we can utilize the powerful capabilities of cellular phones to provide additional services. For an emergency, the cellular phone can display critical medical information such as blood type, allergies, and special medical conditions that may save the life of a patient. The cellular phone also can use its wireless signal transfer capability to transfer information directly to computers or other devices to improve the efficiency of paperwork.

FIG. 7(e) is a flow chart describing an example of the method of using cellular phones to serve the functions of a membership card. Examples of membership cards are health club memberships, airline frequent flyer membership, student identification cards, library cards, tennis club membership cards, preferred customer card for a shop, . . . etc. The membership mode can be activated by the membership provider or the user using security protection methods of the present invention. To use the membership information, the user can execute self verification so that the cellular phone knows the right owner is using its service. After the self verification has passed, the user can select the proper membership in case he carries more than one membership card in his cellular phone database. The cellular phone can display an image of membership card on the LCD panel, or send signals to a signal receiver owned by the membership club using methods illustrated in FIGS. 5(a-c). The membership club may request further verification before providing services.

A cellular phone will be able to carry a large number of membership cards. In addition, we can utilize the powerful capabilities of cellular phones to provide additional services. For example, the cellular phone can use its wireless signal transfer capability to transfer information directly to computers owned by membership clubs. The users also can use cellular phones to make reservations while allowing the membership clubs to verify identity at the same time. The cellular phone also can behave as a charge card or a gift certificate card that displays a balance and subtracts a payment from the balance after a transaction.

While specific embodiments of the invention have been illustrated and described herein, it is realized that other modifications and changes will occur to those skilled in the art. Remote controllers and keys were discussed earlier but cellular phones can support other prior art devices as well. For example, a cellular phone can be used to serve the functions of an entertainment player.

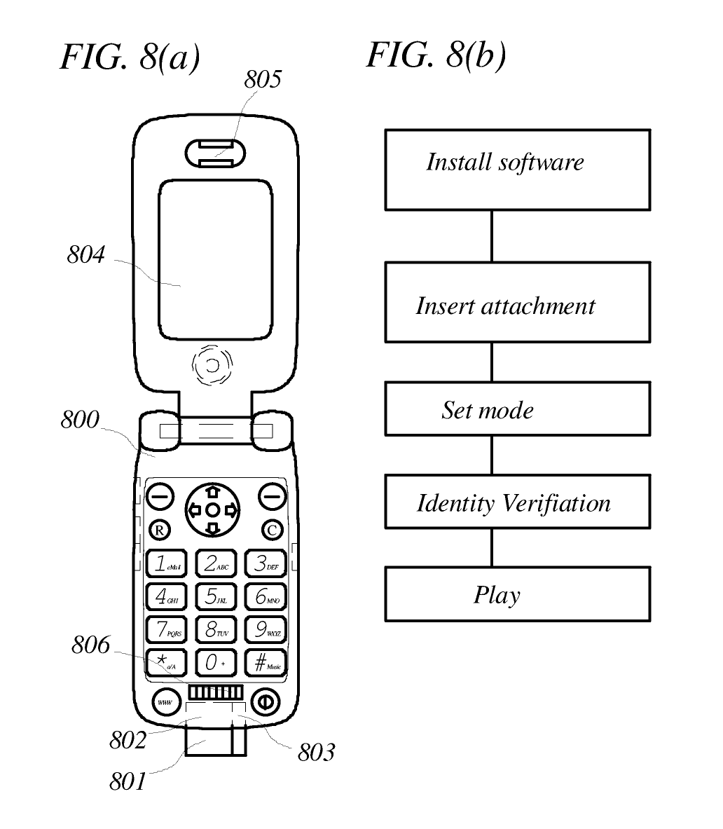

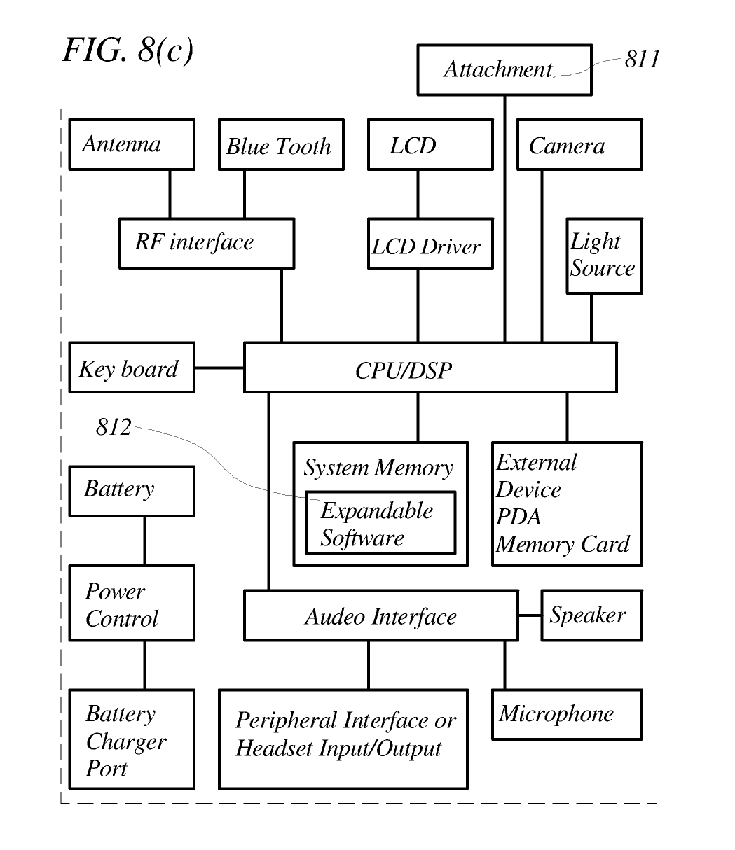

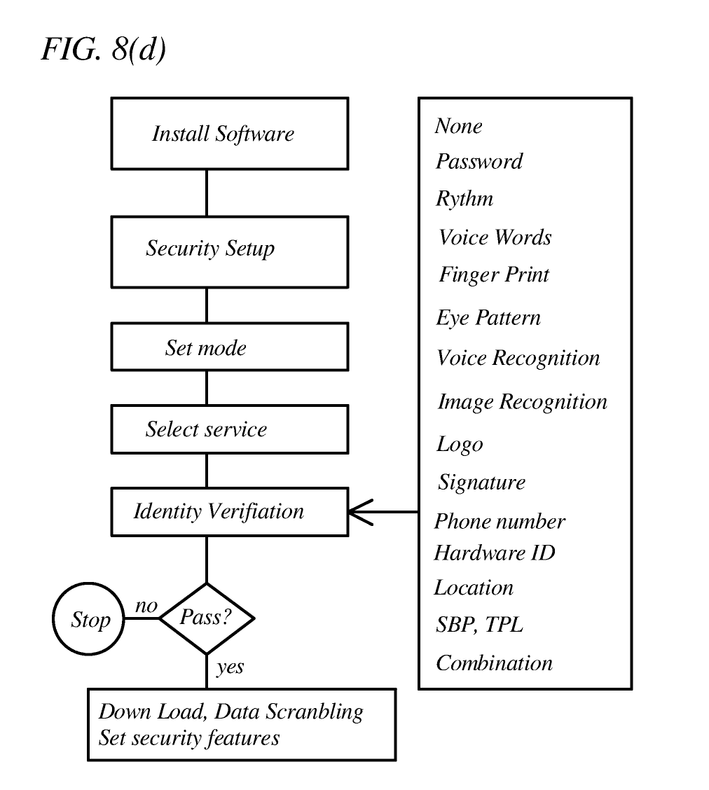

FIG. 8(a) illustrates a cellular phone (800) that has the same structure as the prior art cellular phone (100) in FIG. 1(a) except it is equipped with an attachment (801) used to store music files. The attachment typically includes storage devices and controllers (e.g. a FLASH memory card). In this example, the attachment connects to the headset interface port (802) and battery charger input port (803). The attachment (801) also can use other types of interfaces to the cellular phone (800). FIG. 8(c) is the functional block diagram for the cellular phone in FIG. 8(a).

FIG. 8(b) is a flow chart showing example procedures used to install entertainment player functions onto the cellular phone. The first step is to install a software program. For example, the software can take the data in the attachment and use it to play a song through the speakers (805). Music video files could also be played using the phone screen (804) to display the video portion of the file. Movies can also be displayed on the screen. A Karaoke function could also be supported using the microphone (806) to record voice. In this way, songs can be edited with the user's recorded voice replacing or supporting the original track. Once the software is in the cellular phone, the next step is to insert the attachment. In this method, the attachment already has entertainment files stored in it. We also can use cellular phone internal storage capabilities instead of the attachment. The next step is to set the cellular phone in entertainment player mode. Identity verification follows. If the identity of the user is verified, the user will be allowed to use play the entertainment files in the attachment.

FIG. 8(c) is a block diagram that shows that the cellular phone in FIG. 8(a) has all the typical components of a prior art cellular phone, which are depicted in FIG. 2, but it has an additional attachment (811) and extra space in system memory (812) to allow the installation of additional software.

FIG. 8(d) is a flow chart showing example procedures used to install entertainment player functions onto the cellular phone with the additional feature of allowing entertainment downloads through cellular stations, internet, or CDC communications. The first step is to install entertainment player software in the system. A user applies for approval from an entertainment service provider. The service provider installs entertainment player software on the cellular phone of the applicant, or activates such mode from a built-in function provided by the cellular phone manufacturer. The installation procedures are protected by security methods of the present invention so that both the user and the service provider are protected. Security is then set up with the user choosing a password or using any combination of the other identity verifications discussed before. The music player software can play the entertainment files in the attachment or download additional files through cellular stations or the internet. To do so, the user sets the cellular phone in music player mode. The user then selects a service. For example, the user may select to play music files from the attachment. Identification verification follows. If the user's identity is verified, the software plays the music files in the attachment. The user may also select to download music files to the attachment. Identification verification follows. It may be desirable to run different sets of identity checks for each service. If identity verification passes, the desired music files are downloaded. If identity verification fails, the process stops. It is important to note that using the security methods the present invention, service providers are protected. Service providers are assigned “guest user” identity so they have full control over their property. In this way, music files cannot be copied or modified without the provider's consent. It is also possible to use data scrambling as additional protection to the providers.

It is desirable that the cellular phone can still respond to critical functions while in entertainment player mode. For example, it should still ring when there is an incoming phone call.

The present invention provides methods of implementing expandable cellular phone functions. Resource management methods/structures such as cellular phone identity verification methods, the “guest user”, the “sterilized-by-provider” (SBP), the “trusted-provider-list” (TPL), the “resource access priority level” (RAPL), and the “cellular phone direct communication” (CDC) are provided to make implementations of expandable functions more secure and more convenient. The “resource management system” discussed in the present invention can be as complex as prior art operating systems, or as simple as a built-in application software installed in cellular phone to manage part of a cellular phone's resources. Practical application examples in remote controllers and personal identity services are discussed to facilitate understanding of the present invention.

A modern man typically carries three items in his pocket—a wallet, a chain of keys, and a cellular phone. Upon disclosure of the present invention, people may only need to carry a cellular phone in the near future.

While specific embodiments of the invention have been illustrated and described herein, it is realized that other modifications and changes will occur to those skilled in the art. The security features of the present invention are not only applicable to cellular phones but also applicable to computers and other systems.

It is to be understood that the appended claims are intended to cover modifications and changes as fall within the true spirit and scope of the invention.

What is claimed is:

1. A method for controlling the read and/or write operations on cellular phone resources, said method comprising the steps of
(a) providing a mechanism to assign the ownership of a cellular phone resource to one or more identities;
(b) defining a plurality of priority levels for limiting the operations to access cellular phone resources, said priority levels including at least one level that disallows a user to modify a resource, and one level that disallows a user to read a resource;
(c) providing a guest user identity that is allowed to obtain ownership on a cellular phone resource and define the read and/or write priority levels of said resource, wherein the limitation on read and/or modify operations enforced by the guess user on said resource can not be overwritten by other users, including the system user, without the permission of the guest user.

2. A method of claim 1 that is used to support the functions of credit cards using cellular phones.

3. A method of claim 1 that is used to support the functions of automatic teller machine card using cellular phones.

4. A method of claim 1 that is used to support the functions of membership cards using cellular phones.

5. A method of claim 1 that is used to support the functions of insurance cards using cellular phones.

6. A method of claim 1 that is used to support the functions of business cards using cellular phones.

7. A method of claim 1 that is used to support the functions of music players using cellular phones.

8. A method of claim 1 that is used to support the functions of movie displays using cellular phones.

9. A method for configuring a cellular phone to support the functions of a remote controller.

10. The method in claim 9 further comprises the step of connecting an infrared (IR) emitter as the signal emitter.

11. The remote controller in claim 9 is a television remote controller.

12. The remote controller in claim 9 is a remote controlled key.

13. A method for providing one-to-one cellular phone data communication, where the output data from one cellular are directly transferred to another cellular phone.

14. The two cellular phones in claim 13 are lined by a wire.

15. The signal transfer method in claim 13 is modulated voice signals.

16. The signal transfer method in claim 13 is modulated infrared signals.
